(19) United States
(12) Patent Application Publication
(10) Pub. No.: US 2026/0016962 A1
(43) Pub. Date: Jan. 15, 2026

(54) Ternary Content Addressable Memory System

(71) Applicant: Cisco Technology, Inc., San Jose, CA (US)

(72) Inventors: Guy Caspary, CAESAREA (IL); Mel Tsai, Palo Alto, CA (US)

(21) Appl. No.: 18/769,238

(22) Filed: Jul. 10, 2024

(51) Int. Cl. G06F 3/06

(52) U.S. Cl. CPC G06F 3/0613; G06F 3/064; G06F 3/0673

(57) ABSTRACT

Devices, networks, systems, methods, and processes for facilitating parallel processing in ternary content addressable memory (TCAM) systems are described herein. A TCAM system including two physical TCAM blocks may detect a key-type associated with a key entry. The TCAM system can be operated in a wide search mode or a narrow search mode based on the detected key-type. In the narrow search mode, the key entry, being a narrow key, is inputted to the two physical TCAM blocks for associated data look-up. In the wide search mode, the key entry, being a wide key, is split into two segments, and one segment is inputted to one TCAM block and the other segment is inputted to the other TCAM block. The TCAM system may implement multiple logical TCAMs using the physical TCAM blocks. Thus, integrating a hybrid architecture of hardwired logic followed by programmable logic configuration, enhanced by parallel processing.

The present disclosure relates to communication systems. More particularly, the present disclosure relates to ternary content addressable memory system in network switches.

### BACKGROUND

Network switches are important components in communication networks, serving as the backbone that interconnects various devices within a network. The network switches direct data packets to the correct destination, enhance network efficiency, and reduce unnecessary traffic, leading to improved performance and security. The network switches also provide routing capabilities to manage and isolate traffic effectively. Overall, network switches play a vital role in ensuring seamless, high-speed data transfer and reliable communication within modern digital infrastructures.

Content Addressable Memory (CAM) is extensively utilized in network switches to enhance the efficiency and speed of communication. CAM enables rapid data lookup by comparing input search data against a table of stored entries in parallel, significantly speeding up address resolution and routing processes. In network switches, CAM is often employed to quickly determine the appropriate output port for incoming packets by matching destination addresses. This capability is important in supporting high-speed networking, as it minimizes the latency associated with address resolution. By using CAM, network switches can handle a large number of simultaneous data flows with low latency, ensuring efficient data transmission and optimal network performance.

However, CAM has limitations when it comes to implementing more complex searching and matching criteria required for modern network functionalities such as access control lists (ACLs), quality of service (QOS), and routing tables. To address these limitations, ternary content addressable memory (TCAM) is employed. TCAM extends the capabilities of CAM by supporting ternary logic (0, 1, and ‘X’ for don't care), allowing for more flexible and efficient pattern matching. This capability enables TCAM to handle multiple matching rules simultaneously and support the complex, multi-field searches needed for advanced network policies and security measures. Additionally, the network switches have to handle a diverse range of functionalities and requirements, for example, from routine, well-defined operations to dynamic and complex operations that evolve over time. Consequently, an inflexible TCAM database searching approach may perform exceptionally well for one type of operations but can fail to meet the demands of other types of operations.

### SUMMARY OF THE DISCLOSURE

Systems and methods associated with ternary content addressable memory in accordance with embodiments of the disclosure are described herein. In some embodiments, a ternary content addressable memory (TCAM) system includes a first TCAM block and a second TCAM block, and a TCAM logic configured to receive a key entry, detect a key-type associated with the key entry, and operate the TCAM system in one of a wide search mode or a narrow search mode based on the detected key-type, wherein in the narrow search mode, the TCAM logic is further configured to input the key entry to the first TCAM block and the second TCAM block, and in the wide search mode, the TCAM logic is further configured to split the key entry into a first key segment and a second key segment, and input the first key segment and the second key segment to the first TCAM block and the second TCAM block, respectively.

In some embodiments, the first TCAM block and the second TCAM block are physical TCAM blocks.

In some embodiments, the first TCAM block and the second TCAM block are populated based on at least one logical TCAM.

In some embodiments, the at least one logical TCAM includes one or more 512-bit entries and one or more 256-bit entries.

In some embodiments, the first TCAM block is configured to store a first plurality of entries and the second TCAM block is configured to store a second plurality of entries.

In some embodiments, a plurality of priority decoders are coupled to the first TCAM block and the second TCAM block, and a plurality of associated data look-ups are coupled to the plurality of priority decoders.

In some embodiments, the key-type is one of a narrow key or a wide key.

In some embodiments, a size of the narrow key is smaller than a size of the wide key.

In some embodiments, the TCAM logic is further configured to operate the TCAM system in the narrow search mode in response to detecting that the key-type is the narrow key.

In some embodiments, in response to inputting the key entry to the first TCAM block and the second TCAM block, the first TCAM block is further configured to generate a first hit-bitmap based on the key entry and the first plurality of entries, and the second TCAM block is further configured to generate a second hit-bitmap based on the key entry and the second plurality of entries.

In some embodiments, the TCAM logic is further configured to interleave the first hit-bitmap with the second hit-bitmap to obtain an interleaved hit-bitmap and provide the interleaved hit-bitmap to the plurality of priority decoders.

In some embodiments, the plurality of priority decoders is configured to output one or more index values based on the interleaved hit-bitmap, and the plurality of associated data look-ups is configured to output a set of results mapped to the one or more index values.

In some embodiments, the TCAM logic is further configured to merge the set of results, and obtain, based on the merging of the set of results, a single result configured to indicate at least one action.

In some embodiments, the TCAM logic is further configured to operate the TCAM system in the wide search mode in response to detecting that the key-type is the wide key.

In some embodiments, in response to inputting the first key segment to the first TCAM block and the second key segment to the second TCAM block, the first TCAM block is further configured to generate a first hit-bitmap based on the inputted first key segment and the first plurality of entries, and the second TCAM block is further configured to generate a second hit-bitmap based on the inputted second key segment and the second plurality of entries.

In some embodiments, the TCAM logic is further configured to generate a merged hit-bitmap based on the first hit-bitmap and the second hit-bitmap and interleave the merged hit-bitmap with a plurality of zeros to obtain an interleaved hit-bitmap.

In some embodiments, the plurality of priority decoders is configured to output one or more index values based on the interleaved hit-bitmap, and the plurality of associated data look-ups is configured to output a set of results mapped to the one or more index values.

In some embodiments, the TCAM logic is further configured to merge the set of results, and obtain, based on the merging of the set of results, a single result configured to indicate at least one action.

In some embodiments, a ternary content addressable memory (TCAM) system includes a plurality of TCAMs including at least a first TCAM and a second TCAM, wherein the first TCAM includes a plurality of even TCAM blocks, and the second TCAM includes a plurality of odd TCAM blocks, and a TCAM logic configured to receive a plurality of key entries, and allocate a set of TCAM blocks to each key entry of the plurality of key entries, wherein the set of TCAM blocks includes at least an even TCAM block and an odd TCAM block, and the set of TCAM blocks allocated to each key entry is utilized to identify one or more hits to a corresponding key entry.

In some embodiments, a method includes receiving a key entry, detecting a key-type associated with the key entry, and operating a ternary content addressable memory (TCAM) system, including at least a first TCAM block and a second TCAM block, in one of a wide search mode or a narrow search mode based on the detected key-type, wherein operating the TCAM system in the narrow search mode includes inputting the key entry to the first TCAM block and the second TCAM, and operating the TCAM system in the wide search mode includes splitting the key entry into a first key segment and a second key segment, and inputting the first key segment and the second key segment to the first TCAM block and the second TCAM block, respectively.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a network device in accordance with various embodiments of the disclosure;

FIG. 2 is a schematic block diagram of a ternary content addressable memory (TCAM) system in accordance with various embodiments of the disclosure;

FIG. 3 is a schematic diagram that illustrates physical TCAM blocks populated based on an example logical TCAM in accordance with various embodiments of the disclosure;

FIG. 4 is a schematic block diagram of a TCAM system in accordance with various embodiments of the disclosure;

FIG. 5 is a schematic diagram illustrating merging of results in a TCAM system in accordance with various embodiments of the disclosure;

FIG. 6 is a flowchart showing a process for enabling parallel processing in a TCAM system in accordance with various embodiments of the disclosure;

FIG. 7 is a flowchart showing a process for facilitating operation of a TCAM system in a wide search mode in accordance with various embodiments of the disclosure;

FIG. 8 is a flowchart showing a process for facilitating operation of a TCAM system in a narrow search mode in accordance with various embodiments of the disclosure;

FIG. 9 is a flowchart showing a process for enabling parallel processing in a TCAM system in accordance with various embodiments of the disclosure; and

FIG. 10 is a conceptual block diagram of a device suitable for configuration with a TCAM logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that facilitate parallel processing in network switches. Various embodiments of the present disclosure attempt to facilitate parallel processing in network switches. The network switches have to handle a diverse range of functionalities and requirements, for example, from routine, well-defined operations to dynamic and complex operations that evolve over time. Consequently, an inflexible TCAM database searching approach may perform exceptionally well for one type of operations but can fail to meet the demands of other types of operations. Thus, conventional TCAM systems fails to handle diverse and dynamic nature of tasks. Various embodiments of the present disclosure attempt to facilitate handling of diverse and dynamic nature of the tasks.

In many embodiments, a ternary content addressable memory (TCAM) system may include a TCAM processor and a two TCAM blocks. The two TCAM blocks are physical blocks. Each TCAM block may include multiple entries. The TCAM processor may receive a key entry. The key entry may be associated with a packet. A packet is a formatted unit of data transmitted across a network, containing control information and payload to enable routing and delivery. The TCAM processor may detect a key-type associated with the key entry. The TCAM processor may operate the TCAM system in one of a narrow search mode or a wide search mode to find one or more hits to the key entry based on the detected key-type. In a variety of embodiments, the TCAM processor may operate the TCAM system in the narrow search mode in response detecting that the key-type is a narrow key. In such embodiments, the key entry may be input to the first TCAM block and the second TCAM block to process the data packet. In a number of embodiments, the TCAM processor may operate the TCAM system in the wide search mode in response detecting that the key-type is a wide key. In such embodiments, the TCAM processor may split the key entry into a first key segment and a second key segment. Further, the TCAM processor may input the first key segment to the first TCAM block and the second key segment to the second TCAM block to process the data packet associated with the key entry. Multiple logical TCAMs each corresponding to various functions may be realized via the first and second TCAM blocks. Additionally, the disclosed TCAM system can handle both wide keys and narrow keys. Thus, the disclosed TCAM system implements hardwired logic and programmable logic, thereby achieving parallel processing and dynamic behavior.

In many embodiments, TCAM system may include a TCAM processor and at least two physical TCAMs. Further, one physical TCAM may include a multiple even TCAM blocks and the other physical TCAM may include multiple odd TCAM blocks. A TCAM block may correspond to a specific portion of the physical TCAM. Each TCAM block may include corresponding entries. An even TCAM and an odd TCAM may form one or more logical TCAMs. Thus, two physical TCAMs facilitate implementation of multiple logical TCAMs, where each logical TCAM is associated with a set of rules for a function. Further, the TCAM processor may receive multiple key entries associated with multiple packets. The TCAM processor may detect a key-type associated with each key entry. Further, when the key-type of a key entry is a narrow key, the TCAM processor may allocate at least an even TCAM block and an odd TCAM block to find one or more hits the corresponding key entry. Furthermore, when the key-type of a key entry is a broad key, the TCAM processor may split the key entry into two segments and inputs one segment to an even TCAM block and another segment to an odd TCAM block to find one or more hits the corresponding key entry. The multiple even and odd TCAM blocks may find one or more hits to the corresponding key entry, simultaneously.

As a result of above-described embodiments, parallel processing is enabled in the TCAM systems that are used in network devices. The disclosed TCAM system implements hardwired logic and programmable logic, thereby achieving parallel processing and dynamic behavior. Also, the physical TCAMs are efficiently utilized to implement multiple logical TCAMs that correspond to multiple functions. The TCAM system can be used for high-speed, efficient packet processing and forwarding. The TCAM system can allow a network device to perform lookups in parallel across multiple entries. Additionally, the TCAM system can handle exact matches, wildcard matches, and range matches, enabling fast decision-making and low-latency forwarding.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not be limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in further embodiments, may alternatively be embodied by or implemented as a component.

A circuit, as used herein, comprises a set of one or more electrical and/or electronic components providing one or more pathways for electrical current. In further embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in further embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

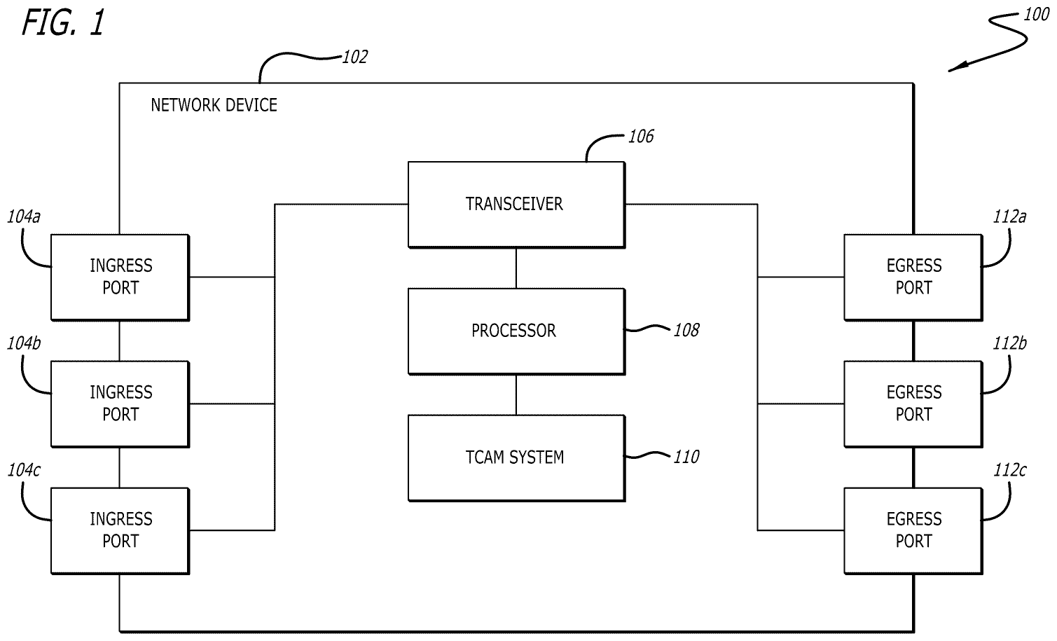

Referring to FIG. 1, a schematic block diagram of a network device 100 in accordance with various embodiments of the disclosure is shown. The network device 100 may be configured to manage, direct, and facilitate data communication across various networks such as local area networks (LANs), wide area networks (WANs), and other interconnected networks. Examples of the network device 100 may include a router, a switch, a hub, a gateway, an access point, or the like. In the embodiments depicted in FIG. 1, the network device 100 is shown to include a plurality of ingress ports 104a-104c, a transceiver 106, a processor 108, a ternary content addressable memory (TCAM) system 110, and a plurality of egress ports 112a-112c.

In many embodiments, the plurality of ingress ports 104a-104c may correspond to entry points where one or more packets enter the network device 100 from external devices. In other words, the plurality of ingress ports 104a-104c may receive incoming traffic from the external devices. In numerous embodiments, the plurality of egress ports 112a-112c may correspond to exit points where the one or more packets leave the network device 100 to reach their intended destinations. For example, after the incoming traffic at the plurality of ingress ports 104a-104c is processed, the incoming traffic is directed to appropriate plurality of egress ports 112a-112c for orderly and optimized data transmission. Examples of the plurality of ingress ports 104a-104c and the plurality of egress ports 112a-112c may include, but are not limited to, Ethernet Ports, Fiber Optic Ports, or the like.

In various embodiments, the transceiver 106 may be coupled to the plurality of ingress ports 104a-104c and the plurality of egress ports 112a-112c. Further, the transceiver 106 may be configured to receive the one or more packets from various other network devices via the plurality of ingress ports 104a-104c. Packets may correspond to units of data formatted for transmission across various networks. A packet may include a payload (actual data being transmitted) and one or more headers indicating control information such as source and destination addresses, communication protocol, error detection codes, or the like.

In a number of embodiments, the transceiver 106 may be further coupled to the processor 108. The processor 108 may be configured to receive the one or more packets from the transceiver 106. In a variety of embodiments, the processor 108 may be configured to provide the one or more packets to the TCAM system 110. In response, the processor 108 may receive a set of actions from the TCAM system 110. The set of actions may indicate actions to be performed on the one or more packets. In more embodiments, the processor 108 may be further configured to process the one or more packets based on the set of actions. In an example, the processor 108 may transmit a packet of the one or more packets via the transceiver 106 and the plurality of egress ports 112a-112c to other network devices. In another example, the processor 108 may discard (e.g., drop) another packet of the one or more packets. In yet another example, the processor 108 may modify yet another packet of the one or more packets prior to transmitting to other network devices. Examples of the processor 108 may include an application-specific integrated circuit (ASIC) processor, a reduced instruction set computer (RISC) processor, a complex instruction set computer (CISC) processor, a field programmable gate array (FPGA), a central processing unit (CPU), or the like.

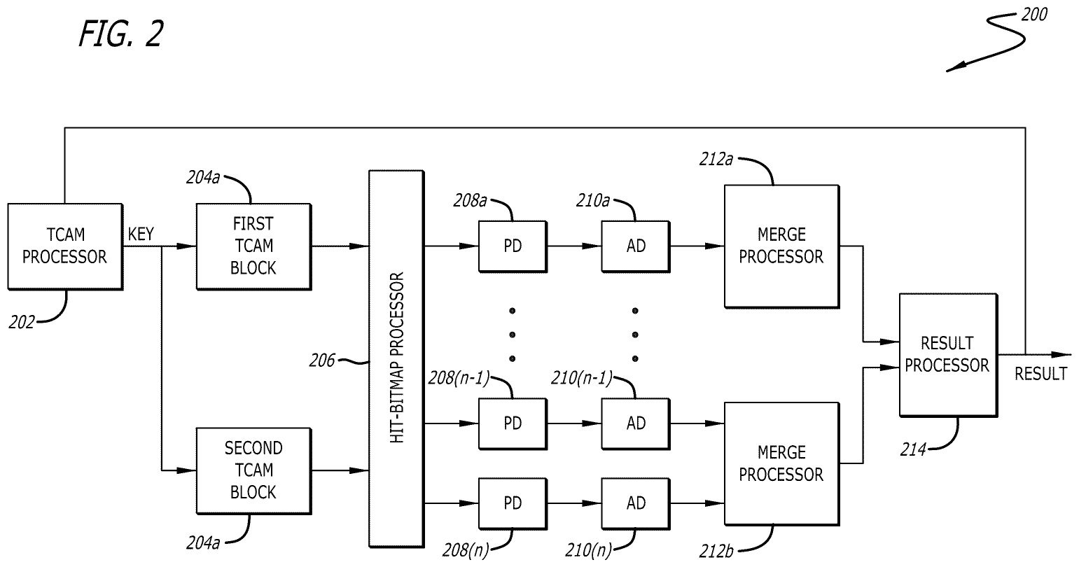

In additional embodiments, the TCAM system 110 may be configured to store access control lists (ACLs), quality of service (QOS), and other information. ACLs may include a series of rules that define whether a received packet should be permitted or denied based on various criteria (such as source/destination Internet Protocol (IP) addresses, source/destination Media Access Control (MAC) addresses, ports, communication protocols, or the like) associated with the packet. Examples of ACLs may include port ACL, virtual LAN ACL, security ACL, route ACL, or the like. QoS may aid in high-speed packet classification and filtering to prioritize network traffic and ensure optimal performance for critical applications. In further embodiments, the TCAM system 110 may be configured to receive the one or more packets, process the one or more packets based on the ACLs and QoS, and provide the set of actions associated with each of the one or more packets to the processor 108. Operation of the TCAM system 110 is described in detail in conjunction with FIG. 2.

In still additional embodiments, the network device 100 may correspond to an Artificial Intelligence (AI) packet processor. The AI packet processor may introduce a two-tiered Network Processing Unit (NPU) structure within a switch, featuring dedicated processing units (e.g., TCAM systems) for ultra-low latency AI packet processing (AIPP) and traditional Layer 2/3/4 functions. Such an architecture can enable cost and power savings, eliminating the need for a discrete Network Interface Card (NIC) with TCAM systems. Leveraging the interfaces already connecting Graphics Processor Units (GPUs) to other components, this configuration can provide a cost-effective and space-efficient solution. By combining AI packet processing (e.g., TCAM based approach) with existing GPU interfaces, both cost and device footprint can be optimized.

Although in FIG. 1 the network device 100 is shown to include three ingress ports 104a-104c and three egress ports 112a-112c, the scope of the present disclosure is not limited to it. In still further embodiments, the network device 100 can include any number of ingress ports and egress ports without deviating from the scope of the disclosure.

Although a specific embodiment of a network device suitable for carrying out the various steps, processes, methods, and operations described herein is discussed with respect to FIG. 1, any of a variety of systems and/or processes may be utilized in accordance with embodiments of the disclosure. For some examples, in several embodiments, the network device 102 can additionally or alternatively include a plurality of bidirectional ports that can be utilized for both ingress and egress operations. The elements depicted in FIG. 1 may also be interchangeable with other elements of FIGS. 2-10 as required to realize a particularly desired embodiment.

Referring to FIG. 2, a schematic block diagram of a TCAM system 200 in accordance with various embodiments of the disclosure is shown. The TCAM system 200 can be used for high-speed, efficient packet processing and forwarding. The TCAM system 200 may allow a network device to perform lookups in parallel across multiple entries. The TCAM system 200 can handle exact matches, wildcard matches, and range matches, enabling fast decision-making and low-latency forwarding. In the embodiments depicted in FIG. 2, the TCAM system 200 is shown to include a TCAM processor 202, a first TCAM block 204a, a second TCAM block 204b, a hit-bitmap processor 206, a plurality of priority decoders 208a-208n, a plurality of Associated Data (AD) look-ups 210a-210n, a first merge processor 212a, a second merge processor 212b, and a result processor 214.

In many embodiments, the TCAM processor 202 may be configured to store a first plurality of entries and a second plurality of entries in the first TCAM block 204a and the second TCAM block 204b, respectively. The first plurality of entries and the second plurality of entries may correspond to one or more of ACLs, QoS, and packet routing information.

In a variety of embodiments, the TCAM processor 202 may be configured to convert the ACLs, QoS, and packet routing information to ternary form. Ternary form corresponds to data stored in three states such as 0, 1, and don't care (X). Further, the TCAM processor 202 may store the one or more of ACLs, QoS, and packet routing information in the ternary form as the first plurality of entries and the second plurality of entries in the first TCAM block 204a and the second TCAM block 204b, respectively.

In more embodiments, the ternary form of the ACLs, QoS, and packet routing information can be in a value, mask, and result (VMR) format. The value in VMR may refer to a pattern that is to be matched. Examples of the value may include IP address, protocol ports, differentiated services code point (DSCP), or the like associated with a packet. The mask may refer to one or more mask bits associated with the pattern, indicating which bits of the value are relevant for the match operation. The result may refer to the result or action that occurs in the case where a lookup returns a hit for the pattern and mask. In additional embodiments, in case of an ACL rule, the result may be one of permit or deny. In case of the QoS, the result may be a value that may be utilized to identify corresponding QoS policies. In case of the packet routing information, the result may be a pointer that may be utilized to identify a next hop for the packet.

In a number of embodiments, the TCAM processor 202 may be further configured to receive a packet. The packet may include at least one header, a payload, and a trailer. The header may include control information necessary for routing and managing the packet through the network. The control information may include source and destination addresses, sequence number, packet length, protocol information, or the like. The payload may refer to actual data being transmitted, that may be a part of a file, a message, or any other type of information. The trailer may include error-checking and error-correction fields such as a checksum, that allows a receiving device to detect any errors that may have occurred during transmission of the corresponding packet.

In still more embodiments, the TCAM processor 202 may be further configured to receive (or generate) a key entry for the packet. In still more embodiments, the key entry may be based on one or more of the source address, the destination address, the source port, the destination port, the DSCP, the protocol, or the like, associated with the packet. In still further embodiments, the key entry may be in a binary form, e.g., represented in 0s and 1s.

In still additional embodiments, the TCAM processor 202 may be further configured to detect a key-type associated with the key entry. The key-type may correspond to one of a wide key or a narrow key. In some embodiments, the key-type associated with the key entry may be based on an IP protocol associated with the packet. For example, a key entry of an IP version 4 (IPv4) packet can be a narrow key, while a key entry of an IPV6 packet can be a wide key. In still yet more embodiments, the TCAM processor 202 may detect the key-type associated with the key entry based on a size of the key entry. A size of the narrow key may be smaller than a size of the wide key. For example, the size of the narrow key can be 256 bits and the size of the wide key can be 512 bits. Thus, the TCAM processor 202 may detect the key entry as the narrow key if the size of the key entry is 256 bits and detect the key entry as the wide key if the size of the key entry is 512 bits. In many further embodiments, the TCAM processor 202 may detect the key-type of the key entry based on a narrow key enable signal and a value of a least significant bit (LSB) of the key entry. For example, if the LSB of the key entry is set to (‘1’) and the narrow key enable signal is activated, the TCAM processor 202 may detect the key entry as the narrow key. However, if the LSB of the key entry is set to (‘0’) and the narrow key enable signal is activated, the TCAM processor 202 may detect the key entry as the wide key. Additionally, the TCAM processor 202 may detect the key entry as the wide key if the narrow key enable signal is deactivated. In numerous embodiments, the TCAM processor 202 may receive the narrow key enable signal from a processing circuit in the network device.

In many additional embodiments, the TCAM processor 202 may be further configured to input the key entry to the first TCAM block 204a and the second TCAM block 204b in response to detecting that the key-type is the narrow key. In other words, the TCAM processor 202 may operate the TCAM system 200 in a narrow search mode in response to detecting that the key-type is the narrow key. In an example, the key entry may be K[255:0]. In such a scenario, the TCAM processor 202 may input K[255:0] to the first TCAM block 204a and K[255:0] to the second TCAM block 204b.

In still yet additional embodiments, the TCAM processor 202 may be further configured operate the TCAM system 200 in a wide search mode in response to detecting that the key-type is the wide key. In such an embodiment, the TCAM processor 202 may be configured to split the key entry into a first key segment and a second key segment, and input the first key segment to the first TCAM block 204a and the second key segment to the second TCAM block 204b to operate the TCAM system 200 in the wide search mode. In an example, when the key entry is K[511:0], the key entry may be split into K1[511:256] and K2[255:0]. The TCAM processor 202 may input K1[511:256] to the first TCAM block 204a and K2[255:0] to the second TCAM block 204b.

In several embodiments, each of the first and second TCAM blocks 204a and 204b may refer to a specialized type of memory cell array. Each TCAM cell may store one of three states such as 0, 1, and don't care (X). The first and second TCAM blocks 204a and 204b may correspond to physical TCAM blocks. The first and second TCAM blocks 204a and 204b may be configured to include the first plurality of entries and the second plurality of entries, respectively. In many examples, the first plurality of entries and the second plurality of entries may be in the VMR format as described in the above-mentioned embodiments. In further examples, a number of entries in the first plurality of entries may be same as the number of entries in the second plurality of entries.

In several additional embodiments, the first TCAM block 204a and the second TCAM block 204b may be populated based on at least one logical TCAM. FIG. 2 illustrates an example that illustrates two physical TCAM blocks being populated based on at least one logical TCAM. In an example scenario, the logical TCAM can include N number of rows, where each row can either include a 512-bit entry or two 256-bit entries. These entries in the logical TCAM are populated in the first TCAM block 204a and the second TCAM block 204b. For example, each entry in the first TCAM block 204a and the second TCAM block 204b can be 256-bit wide. In such a scenario, the 512-bit entry of the logical TCAM is split into two parts, each being 256 bits wide. These two parts are then separately populated in the first TCAM block 204a and the second TCAM block 204b, respectively, at same index values. Further, the two 256-bit entries in the same row of the logical TCAM are separately populated in the first TCAM block 204a and the second TCAM block 204b, respectively, at same index values. For example, if one of the two 256-bit entries is populated in the first TCAM block 204a at index value ‘4’, the other 256-bit entry gets populated in the second TCAM block 204b at the index value ‘4’.

In numerous embodiments, the first TCAM block 204a and the second TCAM block 204b may be populated based on a plurality of logical TCAMs. In numerous additional embodiments, ACL rules may be divided into various functions such as port ACLs, router ACLs, security ACLs, or the like. A first logical TCAM of the plurality of logical TCAM may correspond to the port ACLs, a second logical TCAM of the plurality of logical TCAM's may correspond to the router ACLs, a third logical TCAM of the plurality of logical TCAM's may correspond to the security ACL, or the like.

In several more embodiments, the first TCAM block 204a may be configured to perform a look-up search for a key entry (e.g., a narrow key or the first key segment of a wide key). For the look-up search, the first TCAM block 204a may compare the key entry with the first plurality of entries. The first TCAM block 204a may compare the key entry with each of the first plurality of entries, simultaneously. Further, the first TCAM block 204a may identify one or more hits and one or more misses to the key entry based on the comparison. An entry in the first plurality of entries can be considered as a hit to the key entry based on a bitwise match between the key entry and the value of the entry depending on the mask of the entry. An entry in the first plurality of entries can be considered as a miss to the key entry based on at least one bit mismatch between the key entry and the value of the entry, except for the don't care bits in the entry.

In several yet more embodiments, the first TCAM block 204a may be further configured to generate a first hit-bitmap based on the one or more hits and the one or more misses with the first plurality of entries. In other words, in response to receiving the key entry as the input, the first TCAM block 204a may report the results of the look-up search among the first plurality of entries by generating the first hit-bitmap. The first hit-bitmap may be a binary representation that indicates whether each entry of the first plurality of entries has matched (e.g., a hit) the key entry or not (e.g., a miss). A number of rows in the first hit-bitmap may be same as the number the first plurality of entries in the first TCAM block 204a to ensure a direct correlation between bit positions and entries themselves. In other words, each bit in the first hit-bitmap may be associated with corresponding entry of the first plurality of entries and can indicate whether the corresponding entry is a hit or miss to the key entry. In an example, if an entry in the first TCAM block 204a matches the key entry, a corresponding bit in the first hit-bitmap can be set to ‘1’ (indicating a hit); however, if the entry does not match the key entry, the corresponding bit can be set to ‘0’ (indicating a miss).

Similarly, the second TCAM block 204b may also generate a second hit-bitmap in based on a key entry (e.g., the same narrow key inputted to the first TCAM block 204a or the second key segment of the wide key) and the second plurality of entries stored in the second TCAM block 204b. The first TCAM block 204a and the second TCAM block 204b may generate the first and second hit-bitmaps, parallelly. Further, the first TCAM block 204a and the second TCAM block 204b may provide the first and second hit-bitmaps to the hit-bitmap processor 206.

In numerous embodiments, the hit-bitmap processor 206 may be configured to receive the first hit-bitmap from the first TCAM block 204a and the second hit-bitmap from the second TCAM block 204b. In numerous additional embodiments, the hit-bitmap processor 206 may further receive an indication from the TCAM processor 202 indicating whether the TCAM system 200 is being operated in the narrow search mode or in the wide search mode.

In the narrow search mode, the hit-bitmap processor 206 may be configured to interleave the first hit-bitmap with the second hit-bitmap to obtain an interleaved hit-bitmap. For example, bits from the first hit-bitmap and the second hit-bitmap can be alternated, such as taking one bit from the first hit-bitmap, then one bit from the second hit-bitmap, and repeating this pattern. Thus, if the first hit-bitmap has bits ‘1010’ and the second hit-bitmap has bits ‘0101’, the interleaved hit-bitmap can be ‘10011001’. The hit-bitmap processor 206 may be further configured to provide the interleaved hit-bitmap to the plurality of priority decoders 208a-208n.

In the wide search mode, the hit-bitmap processor 206 may be configured to generate a merged hit-bitmap based on the first hit-bitmap and the second hit-bitmap. For example, the hit-bitmap processor 206 may perform a logical bitwise AND operation on the first hit-bitmap and the second hit-bitmap to generate the merged hit-bitmap. As the first key segment and the second key segment are portions of the same key entry, performing an AND operation on the first and second hit-bitmaps may ensure that only those bits in the merged hit-bitmap indicate a hit if corresponding bits in both the first and second hit-bitmaps are hits. In furthermore embodiments, the hit-bitmap processor 206 may be further configured to interleave the merged hit-bitmap with a plurality of zeros to obtain an interleaved hit-bitmap. For example, bits from the merged hit-bitmap can be alternated with zeroes, such as taking one bit from the merged hit-bitmap, then interleaving with a zero, and repeating this pattern. Thus, if the merged hit-bitmap has bits ‘1010’, the interleaved hit-bitmap can be ‘10001000’. The hit-bitmap processor 206 may be further configured to provide the interleaved hit-bitmap to the plurality of priority decoders 208a-208n.

In still more embodiments, the plurality of priority decoders 208a-208n may be configured to receive an interleaved hit-bitmap (e.g., the interleaved hit-bitmap from the narrow search mode or the interleaved hit-bitmap from the wide search mode) from the hit-bitmap processor 206. The interleaved hit-bitmap may include more than one hit to the key entry. In such a scenario, the plurality of priority decoders 208a-208n may be configured to output one or more index values based on the interleaved hit-bitmap.

In yet further embodiments, each of the plurality of priority decoders 208a-208n may have a corresponding priority index, which defines an order in which the corresponding priority decoder scans through a received hit-bitmap. For example, each of the plurality of priority decoders 208a-208n may scan the interleaved hit-bitmap from the corresponding highest priority index to the corresponding lowest priority index and select the very first set bit that the corresponding priority decoder encounters during the scan. Further, each of the plurality of priority decoders 208a-208n may then generate an index based on the position of the corresponding selected set bit. In several embodiments, a number of priority decoders in the plurality of priority decoders 208a-208n may be same as the number of entries in the first plurality of entries or the second plurality of entries.

In some embodiments, where the first plurality of entries and the second plurality of entries in the first TCAM block 204a and the second TCAM block 204b, respectively, are in the VMR format, the one or more index values outputted by the plurality of priority decoders 208a-208n may correspond to a set of results stored in the first TCAM block 204a and the second TCAM block 204b. However, in some more embodiments, a result set for the logical TCAMs may be stored in a dedicated Random Access Memory (RAM). In such embodiments, each index value outputted by the plurality of priority decoders 208a-208n may correspond to a physical region in the RAM where a corresponding result is stored.

In yet additional embodiments, the plurality of AD look-ups 210a-210n may be configured to receive the one or more index values from the plurality of priority decoders 208a-208n. Each of the AD look-ups 210a-210n may be configured to output a set of results mapped to the one or more index values. In other words, each of the AD look-ups 210a-210n may map a received index value to a result. For example, based on the one or more index values, the plurality of AD look-ups 210a-210n may look-up in the first TCAM block 204a and the second TCAM block 204b or the dedicated RAM to retrieve the set of results mapped to the one or more index values. In an example, each result may include one or more actions/parameters.

In further additional embodiments, the plurality of AD look-ups 210a-210n may be coupled to the first merge processor 212a and the second merge processor 212b. For example, a first set of AD look-ups 210a-210m may be coupled to the first merge processor 212a and a second set of AD look-ups 210(m+1)-210n may be coupled to the second merge processor 212b.

In a variety of additional embodiments, the first merge processor 212a may be configured to receive a first subset of results outputted by the first set of AD look-ups 210a-210m. The first subset of results may include some redundant actions/parameters, thus the first merge processor 212a may be configured to merge the first subset of results. Likewise, the second merge processor 212b may be configured to receive a second subset of results outputted by the second set of AD look-ups 210(m+1)-210n. The second subset of results may also include some redundant actions/parameters, and the second merge processor 212b may be configured to merge the second subset of results.

In still many embodiments, the first merge processor 212a and the second merge processor 212b may be coupled to the result processor 214. The result processor 214 may be configured to receive merged results from the first and second merge processors 212a and 212b. In additional embodiments, a result may be linked to Associated Data 0 (ADO), and the result variable may be initialized to an initial dataset, such as Dataset A, for example. An enable-bitmap merge may be performed by combining another dataset, Dataset B, with a configuration filter using a bitwise AND operation, and updating the result with a bitwise OR operation. In additional embodiments, a loop may be entered that iterates over a series of actions. For each action, another configuration filter may be utilized to determine if a certain condition is met when applied to Dataset A. In many embodiments, this may be done by verifying if the bitwise AND of Dataset A and the configuration filter at the current action's position yields a non-zero value. If this condition is true, the validity of the action may be verified using a predefined validity check. If the action is deemed invalid, it is set to zero. If the condition is false, the action may be updated using the bitwise AND of Dataset B and the configuration filter at the current position. Finally, the result may be updated by performing a bitwise OR operation between Dataset B and the current action. It should be appreciated that all bitwise OR operations may be performed in parallel to enhance efficiency, without exceeding beyond the spirit and scope of the instant disclosure.

The result processor 214 may be further configured to obtain a single result from the merged results. The single result may be configured to indicate at least one action associated with the key entry. In case of ACLs, the at least one action may correspond to one of permit, deny, or discard. In case of QoS, the at least one action may correspond to one or more QoS policies that indicate marking of the corresponding packet with specific tags or labels for specifying priority of the corresponding packet, indicate header compression of the packet, or the like. In case of QoS, the at least one action may indicate an address of the next hop for the packet.

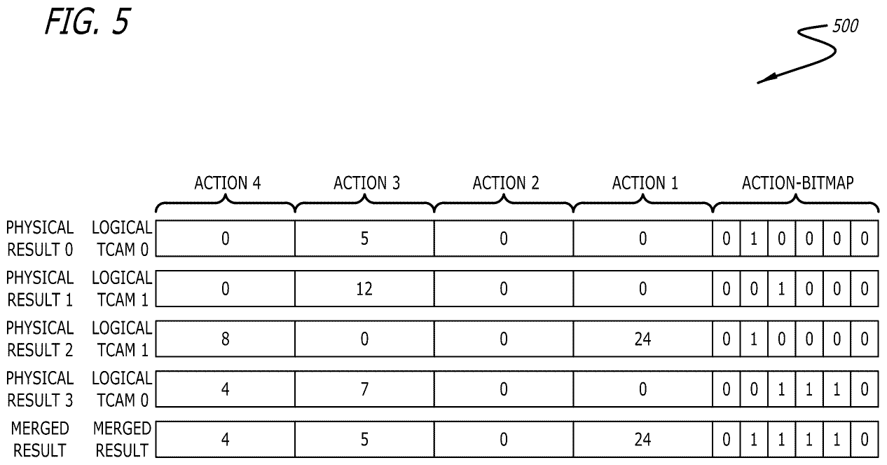

In many further additional embodiments, the TCAM processor 202 may receive the at least one result from the result processor 214. Further, the TCAM processor 202 may process the packet based on the at least one action. Thus, the TCAM system 200 facilitates handling of key entries of different sizes. An example of result merge is described later in conjunction with FIG. 5.

In a number of additional embodiments, examples of the hit-bitmap processor 206, the first merge processor 212a, the second merge processor 212b, or the result processor 214 may include an ASIC processor, a RISC processor, a CISC processor, a FPGA, a CPU, or the like. In many additional embodiments, the hit-bitmap processor 206, the first merge processor 212a, the second merge processor 212b, and the result processor 214 may constitute a TCAM logic.

Although a specific embodiment for a TCAM system suitable for carrying out the various steps, processes, methods, and operations described herein is discussed with respect to FIG. 2, any of a variety of systems and/or processes may be utilized in accordance with embodiments of the disclosure. In several embodiments, the TCAM system 200 may not include the first and second merge processors 212a and 212b, instead the result processor 214 may be further configured to perform the operations of the first and second merge processors 212a and 212b. The elements depicted in FIG. 2 may also be interchangeable with other elements of FIGS. 1 and 3-10 as required to realize a particularly desired embodiment.

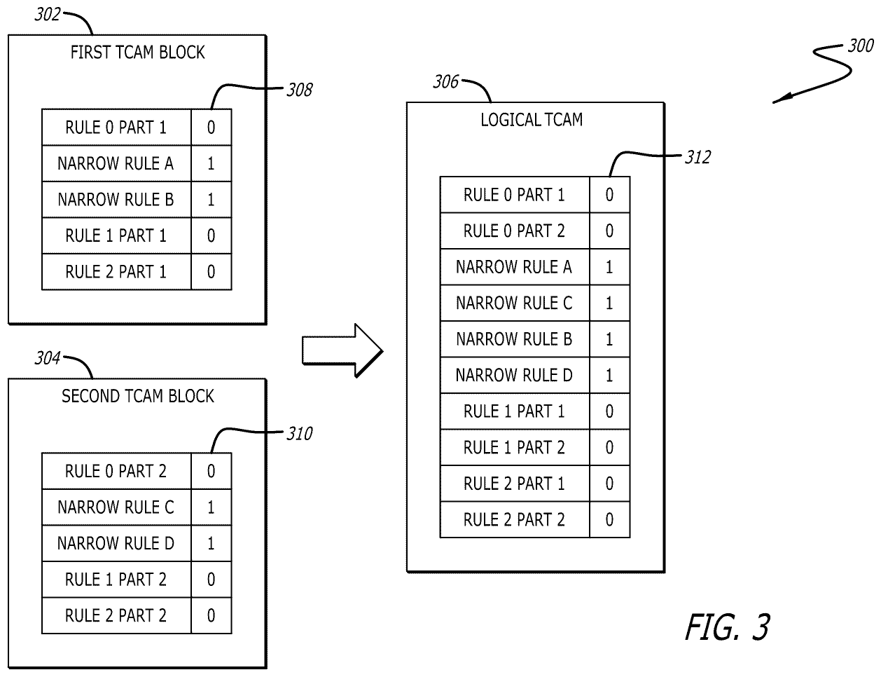

Referring to FIG. 3, a schematic diagram 300 that illustrates physical TCAM blocks populated based on an example logical TCAM in accordance with various embodiments of the disclosure is shown. In the embodiments depicted in FIG. 3, a first TCAM block 302, a second TCAM block 304, and a logical TCAM 306 are shown. The first TCAM block 302 and the second TCAM block 304 correspond to physical TCAM blocks that are populated based on the logical TCAM 306.

The first TCAM block 302 may include a first plurality of entries. For example, the first plurality of entries are shown to include ‘Rule 0 part 1’, ‘Narrow rule A’, ‘Narrow rule B’, ‘Rule 1 part 1’, and ‘Rule 2 part 1’. The first plurality of entries may correspond to rules to be checked for a narrow key entry during a narrow search mode or a first key segment of a wide key entry during a wide search mode. The second TCAM block 304 may include a second plurality of entries. For example, the second plurality of entries are shown to include ‘Rule 0 part 2’, ‘Narrow rule C’, ‘Narrow rule D’, ‘Rule 1 part 2’, and ‘Rule 2 part 2’. The second plurality of entries may correspond to rules to be checked for the narrow key entry during the narrow search mode or a second key segment of the wide key entry during the wide search mode.

In FIG. 3, the first TCAM block 302 is further shown to include a first hit-bitmap 308. The first TCAM block 302 may generate the first hit-bitmap based on a comparison of the narrow key entry or the first key segment with the first plurality of entries. Similarly, the second TCAM block 304 is further shown to include a second hit-bitmap 310. The second TCAM block 304 may generate the second hit-bitmap based on a comparison of the narrow key entry or the second key segment with the second plurality of entries. The first and second hit-bitmaps 308 and 310 may indicate one or more hits (e.g., represented by “1”) and one or misses (e.g., represented by “0”) for corresponding key entries. For example, the first hit-bitmap 308 may indicate that ‘Narrow rule A’ and ‘Narrow rule B’ are hits and the remaining first plurality of entries are misses. Likewise, the second hit-bitmap 310 may indicate that ‘Narrow rule C’ and ‘Narrow rule D’ are hits and the remaining second plurality of entries are misses.

In a number of embodiments, since the first TCAM block 302 and the second TCAM block 304 are populated based on the logical TCAM 306, a logical merging of the first TCAM block 302 and the second TCAM block 304 results in the logical TCAM 306. As shown, the logical TCAM 306 may include ‘Rule 0 part 1’, ‘Rule 0 part 2’, ‘Narrow rule A’, ‘Narrow rule C’, ‘Narrow rule B’, ‘Narrow rule D’, ‘Rule 1 part 1’, ‘Rule 1 part 2’, ‘Rule 2 part 1’, and ‘Rule 2 part 2’. The logical TCAM 306 is also shown to include a logical hit-bitmap 312. In an example, Rule 0 part 1′ and ‘Rule 0 part 2’ may collectively form a first 512-bit entry in the logical TCAM 306. Likewise, the ‘Rule 1 part 1’ and ‘Rule 1 part 2’ may collectively form a second 512-bit entry and ‘Rule 2 part 1’ and ‘Rule 2 part 2’ may collectively form a third 512-bit entry, in the logical TCAM 306. Further, ‘Narrow rule A’, ‘Narrow rule C’, ‘Narrow rule B’, and ‘Narrow rule D’ may correspond to four 256-bit entries in the logical TCAM 306. In several embodiments, the 512-bit entries may form one row in the logical TCAM 306, whereas two 256-bit entries may form another row in the logical TCAM 306. The 512-bit entries may be referred to as wide entries and 256-bit entries may be referred to as narrow entries.

In several additional embodiments, the first TCAM block 302 and the second TCAM block 304 may generate the first hit-bitmap 308 and the second hit-bitmap 310, respectively, based on a search mode (e.g., whether it is the narrow search mode or the wide search mode). For example, in the narrow search mode, entries in the first TCAM block 302 and the second TCAM block 304 corresponding to the wide entries of the logical TCAM 306 may be disabled for the look-up search. In other words, in the narrow search mode, the first TCAM block 302 and the second TCAM block 304 may perform the look-up search in the narrow entries. Similarly, in the wide search mode, entries in the first TCAM block 302 and the second TCAM block 304 corresponding to the narrow entries of the logical TCAM 306 may be disabled for the look-up search. In other words, in the wide search mode, the first TCAM block 302 and the second TCAM block 304 may perform the look-up search in the wide entries.

Although a specific embodiment of physical TCAM blocks populated based on an example logical TCAM suitable for carrying out the various steps, processes, methods, and operations described herein is discussed with respect to FIG. 3, any of a variety of systems and/or processes may be utilized in accordance with embodiments of the disclosure. For some examples, in still further embodiments, the first TCAM block 302 and the second TCAM block 304 can be populated based on a plurality of logical TCAMs. Further, the logical TCAMs can be populated in consecutive or non-consecutive physical regions in the first TCAM block 302 and the second TCAM block 304. The elements depicted in FIG. 3 may also be interchangeable with other elements of FIGS. 1, 2, and 4-10 as required to realize a particularly desired embodiment.

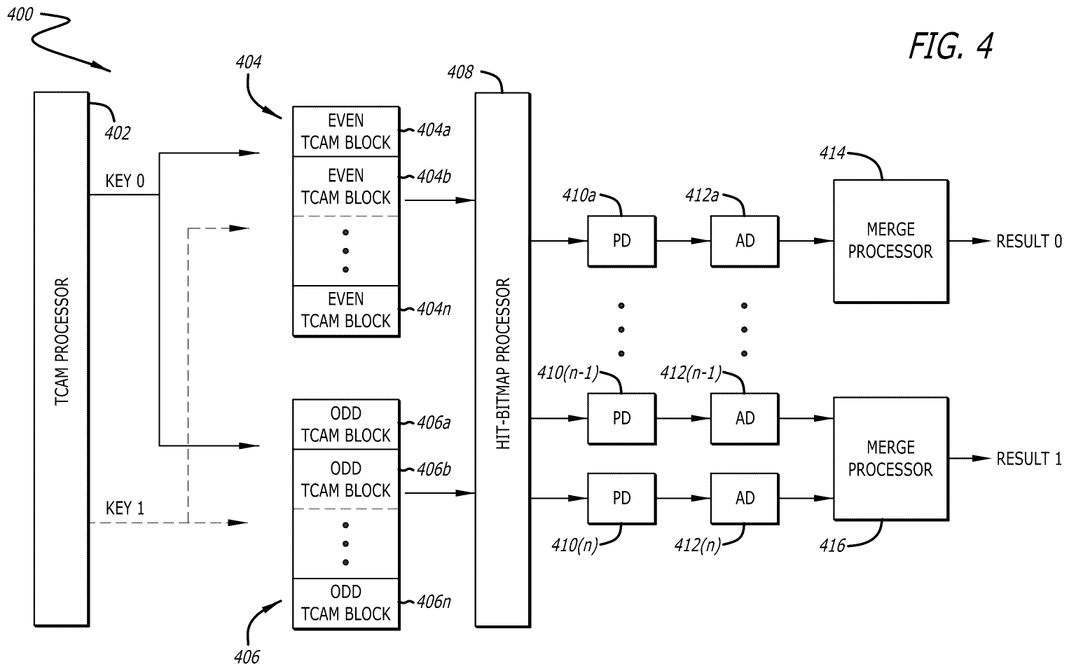

Referring to FIG. 4, a schematic block diagram of a TCAM system 400 in accordance with various embodiments of the disclosure is shown. In the embodiments depicted in FIG. 4, the TCAM system 400 is shown to include a TCAM processor 402, a first TCAM 404, a second TCAM 406, a hit-bitmap processor 408, a plurality of priority decoders 410a-410n, a plurality of AD look-ups 412a-412n, a first merge processor 414, and a second merge processor 416.

In many embodiments, the first TCAM 404 may include a plurality of even TCAM blocks 404a-404n (interchangeably referred to as “even TCAM blocks 404a-404n”). Similarly, the second TCAM 406 may include a plurality of odd TCAM blocks 406a-406n (interchangeably referred to as “odd TCAM blocks 406a-406n”). In a number of embodiments, the first TCAM 404 and the second TCAM 406 may correspond to physical TCAMs. A physical TCAM may refer to a hardware component that includes an array of memory cells. Each TCAM cell may store one of three states such as 0, 1, and don't care (X). A TCAM block may refer to a physical partition in a physical TCAM. In variety of embodiments, the even TCAM blocks 404a-404n and the odd TCAM blocks 406a-406n may be populated based on one or more logical TCAMs. In other words, the even TCAM blocks 404a-404n and the odd TCAM blocks 406a-406n may be utilized to implement the one or more logical TCAMs. For example, the even TCAM blocks 404a-404n and the odd TCAM blocks 406a-406n may be utilized to implement ‘n’ logical TCAMs.

In more embodiments, the TCAM processor 402 may be configured to store a plurality of entries in each of the even TCAM blocks 404a-404n and the odd TCAM blocks 406a-406n. The pluralities of entries may correspond to one or more of ACLs, QOS, packet routing information, or the like. In an example scenario, a first logical TCAM can include N number of rows, where each row can either include a 512-bit entry or two 256-bit entries. These entries in the first logical TCAM are populated in the even TCAM block 404a and the odd TCAM block 406a. For example, each entry in the even TCAM block 404a and the odd TCAM block 406a can be 256 bits wide. In such a scenario, the 512-bit entry of the first logical TCAM is split into two parts, each being 256 bits wide. These two parts are then separately populated in the even TCAM block 404a and the odd TCAM block 406a, respectively, at same index values. Further, the two 256-bit entries in the same row of the first logical TCAM are separately populated in the even TCAM block 404a and the odd TCAM block 406a, respectively, at same index values. For example, if one of the two 256-bit entries is populated in the even TCAM block 404a at index value ‘4’, the other 256-bit entry gets populated in the odd TCAM block 406a at the index value ‘4’. Similarly, remaining even TCAM blocks 404b-404n and remaining odd TCAM blocks 406b-406n can be populated based on one or more other logical TCAMs.

In additional embodiments, the TCAM processor 402 may be configured to convert the ACLs, QoS, and packet routing information to ternary form. Ternary form corresponds to data stored on three states such as 0, 1, and don't care (X). Further, the TCAM processor 402 may store the one or more of ACLs, QoS, and packet routing information in the ternary form in the even TCAM blocks 404a-404n and the odd TCAM blocks 406a-406n. In further embodiments, the ternary form of the ACLs, QoS, and packet routing information can be in a VMR format.

In several embodiments, one or more first logical TCAMs may be associated with forward ACLs and one or more second logical TCAMs may be associated with post-forward ACLs. In several additional embodiments, the forward ACLs may correspond to rules applied to packets as the packets enter a network switch. Forward ACLs may be utilized to inspect incoming packets and determine whether the packets should be allowed or denied. In several more embodiments, the post-forward ACLs may include rules that are applied to packets after the network switch has made a forwarding decision for the packets but before the packets exit the network switch. Post-forward ACLs may provide an additional layer of filtering based on other post-forwarding criteria. Thus, one or more even TCAM blocks 404a-404n and one or more odd TCAM blocks 406a-406n that get populated based on the one or more first logical TCAMs may be utilized for look-up search related to the forward ACLs, while one or more even TCAM blocks 404a-404n and one or more odd TCAM blocks 406a-406n that get populated based on the one or more second logical TCAMs can be utilized for look-up search related to the post-forward ACLs.

In still more embodiments, the TCAM processor 402 may be configured to receive a plurality of key entries. The plurality of key entries may include a first key entry (depicted as Key 0) and a second key entry (depicted as Key 1). In one example, the first key entry be received for a forward ACL look-up for a packet “P1”, and the second key entry may be received for a post-forward ACL look-up for the packet “P1”. In another example, the first key entry may be received for a forward ACL look-up for a packet “P1”, and the second key entry be received for a forward ACL look-up for a packet “P2”. In yet another example, the first key entry may be received for a forward ACL look-up for a packet “P1”, and the second key entry be received for a post-forward ACL look-up for a packet “P2”. In yet additional example, the first key entry may be received for a post-forward ACL look-up for a packet “P1”, and the second key entry be received for a post-forward ACL look-up for a packet “P2”.

In still further embodiments, the TCAM processor 402 may be further configured to detect a key-type associated with each of the first key entry and the second key entry. The key-type may correspond to one of a wide key or a narrow key. The TCAM system 400 may be operated in a narrow search mode or a wide search mode for each of the first key entry and the second key entry.

In still additional embodiments, the TCAM processor 402 may be further configured to allocate a first set of TCAM blocks to the first key entry and a second set of TCAM blocks to the second key entry. In an example, the first set of TCAM blocks may include one or more even TCAM blocks (e.g., the even TCAM block 404a) and one or more odd TCAM blocks (e.g., the odd TCAM block 406a). Likewise, the second set of TCAM blocks may include one or more other even TCAM blocks (e.g., the even TCAM block 404b) and one or more other odd TCAM blocks (e.g., the odd TCAM blocks 406b).

In a scenario where both the first key entry and the second first key entry are wide key entries, the TCAM processor 402 may be configured to split the first key entry into a first key segment and a second key segment, and the second key entry into a third key segment and a fourth key segment. Further, the TCAM processor 402 may input the first key segment to the even TCAM block 404a and the second key segment to the odd TCAM block 406a. Likewise, the TCAM processor 402 may input the third key segment to the even TCAM block 404b and the fourth key segment to the odd TCAM block 406b.

In another scenario both the first key entry and the second first key entry may be narrow key entries. In such a scenario, the TCAM processor 402 may be configured to input the first key entry to the even TCAM block 404a and the odd TCAM block 406a. Likewise, the TCAM processor 402 may input the second key entry to the even TCAM block 404b and the odd TCAM block 406b.

In yet another scenario, the first key entry may be a wide key entry and the second first key entry may be a narrow key entry. In such a scenario, the TCAM processor 402 may split the first key entry into a first key segment and a second key segment and input the first key segment to the even TCAM block 404a and the second key segment to the odd TCAM block 406a. Further, the TCAM processor 402 may input the second key entry to the even TCAM block 404b and the odd TCAM block 406b.

In several more embodiments, in response to receiving an input (e.g., the first key entry or the first key segment), the even TCAM block 404a may be configured to generate a first hit-bitmap based on the input and a first plurality of entries stored on in the even TCAM block 404a. The first hit-bitmap may indicate which all entries among the first plurality of entries matched the input. Likewise, in response to receiving an input (e.g., the first key entry or the second key segment), the odd TCAM block 406a may be configured to generate a second hit-bitmap based on the input and a second plurality of entries stored on in the odd TCAM block 406a. In parallel (e.g., simultaneously), the even TCAM block 404b may generate a third hit-bitmap based on an input (e.g., the second key entry or the third key segment) and a third plurality of entries stored on in the even TCAM block 404b. Further, the odd TCAM block 406b may generate a fourth hit-bitmap based on an input (e.g., the second key entry or the fourth key segment) and a fourth plurality of entries stored on in the odd TCAM block 406b.

In several further embodiments, the hit-bitmap processor 408 may be configured to receive the first hit-bitmap from the even TCAM block 404a and the second hit-bitmap from the odd TCAM block 406a and generate a first interleaved hit-bitmap. Further, the hit-bitmap processor 408 may be configured to receive the third hit-bitmap from the even TCAM block 404b and the fourth hit-bitmap from the odd TCAM block 406b and generate a second interleaved hit-bitmap.

In an example, if the first hit-bitmap and the second hit-bitmap correspond to a narrow search, the hit-bitmap processor 408 may interleave the first hit-bitmap with the second hit-bitmap to obtain the first interleaved hit-bitmap. However, if the first hit-bitmap and the second hit-bitmap correspond to a wide search, the hit-bitmap processor 408 may merge the first hit-bitmap and the second hit-bitmap based on a logical bitwise AND operation and interleave the merged hit-bitmap with a plurality of zeros to obtain the first interleaved hit-bitmap.

Further, if the third hit-bitmap and the fourth hit-bitmap correspond to a narrow search, the hit-bitmap processor 408 may interleave the third hit-bitmap with the fourth hit-bitmap to obtain the second interleaved hit-bitmap. However, if the third hit-bitmap and the fourth hit-bitmap correspond to a wide search, the hit-bitmap processor 408 may merge the third hit-bitmap and the fourth hit-bitmap based on a logical bitwise AND operation and interleave the merged hit-bitmap with a plurality of zeros to obtain the second interleaved hit-bitmap.

In numerous embodiments, the hit-bitmap processor 408 may be configured to provide the first interleaved hit-bitmap to a first set of priority decoders 410a-410m and the second interleaved hit-bitmap to a second set of priority decoders 410m-410n. In yet further embodiments, the first set of priority decoders 410a-410m may be configured to output one or more first index values based on the first interleaved hit-bitmap and provide the one or more first index values to a first set of AD look-ups 412a-412m coupled to the first set of priority decoders 410a-410m. Likewise, the second set of priority decoders 410(m+1)-410n may be configured to output one or more second index values based on the second interleaved hit-bitmap and provide the one or more second index values to a second set of AD look-ups 412(m+1)-412n coupled to the second set of priority decoders 410(m+1)-410n.

In yet additional embodiments, the first set of AD look-ups 412a-412m may be configured to output a first set of results mapped to the one or more first index values and the second set of AD look-ups 412(m+1)-412n may be configured to output a second set of results mapped to the one or more second index values.

In a variety of additional embodiments, the first merge processor 414 may be configured to receive the first set of results from the first set of AD look-ups 412a-412m and the second merge processor 416 may be configured to receive the second set of results from the second set of AD look-ups 412(m+1)-412n. The first set of results may include redundant actions/parameters, thus the first merge processor 414 may be configured to merge the first set of results to obtain a single result for the first key entry. The single result may be configured to indicate one or more actions associated with the first key entry. Similarly, the second set of results may also include redundant actions/parameters, thus the second merge processor 416 may be configured to merge the second set of results to obtain a single result for the second key entry. Thus, the TCAM system 400 can process multiple wide keys and narrow keys, simultaneously.

In a number of additional embodiments, the technical solution involves integrating a hybrid architecture of hardwired logic followed by programmable logic configuration to address multiple challenges. Parallel processing implementation is employed to enhance overall system efficiency by simultaneously executing tasks, while hardware-based merging of database results accelerates data retrieval speed. The ACL implementation spans across data centers and AI networks, and can be extended to service provider networks, showcasing the adaptability and scalability of the present disclosure. Additionally, increased efficiency is achieved by optimizing processing for related or repeated queries, reducing computational load and enhancing overall system responsiveness. This configuration offers a comprehensive solution for parallel processing challenges, data retrieval speed, security standardization, and efficient query processing in diverse network environments.

Although it is described that the TCAM system 400 includes two TCAMs, the scope of the present disclosure is not limited to it. In many more embodiments, the TCAM system 400 may include a plurality of TCAMs that includes more than two TCAMs. Additionally, the plurality of TCAMs may include an even number of TCAMs.

Although a specific embodiment of a TCAM system with parallel processing capability suitable for carrying out the various steps, processes, methods, and operations described herein is discussed with respect to FIG. 4, any of a variety of systems and/or processes may be utilized in accordance with embodiments of the disclosure. For example, in still more embodiments, each entry in the first TCAM 404 and the second TCAM 406 may be associated with a separate counter which gets incremented each time an index value corresponding to the entry is outputted by any of the plurality of priority decoders 410a-410n. The elements depicted in FIG. 4 may also be interchangeable with other elements of FIGS. 1-3 and 5-10 as required to realize a particularly desired embodiment.

Referring to FIG. 5, a schematic diagram 500 illustrating merging of results in a TCAM system in accordance with various embodiments of the disclosure is shown. In the embodiments depicted in FIG. 5, a physical result 0, a physical result 1, a physical result 2, and a physical result 3 are shown. The physical results 0-3 may correspond to outputs of AD look-ups in a TCAM system (e.g., the TCAM system 200 shown in FIG. 2 or the TCAM system 400 shown in FIG. 4). Further, the physical results 0 and 3 may map to a logical TCAM 0, while the physical results 1 and 2 may map to a logical TCAM 1. In an example, the logical TCAM 0 may correspond to a port ACL and the logical TCAM 1 may correspond to a virtual LAN ACL.

In many embodiments, each physical result 0-3 can be an 80/96-bit result. Least significant bits of each physical result 0-3 may include a corresponding action bitmap and most significant bits of each physical result 0-3 may include one or more actions. For example, as shown in FIG. 5, the physical result 0-3 include a first action, a second action, a third action, and a fourth action. Examples of actions can include increment a counter, apply a meter, drop a packet, allow a packet, or the like. These actions are programmable data.

In a variety of embodiment, to obtain a single merged result from the physical results 0-3, a logical OR operation can be performed on the action bitmaps of all physical results 0-3 and first non-zero action from each result is selected. For example, the action bitmaps of the physical results 0-3 are bitwise ORed to obtain a merged action bitmap “011110”. Further, the first non-zero actions ‘4’, ‘5’, and ‘24’ are selected from the physical results 0-3.

Although a specific embodiment for merging of results in a TCAM system for carrying out the various steps, processes, methods, and operations described herein is discussed with respect to FIG. 5, any of a variety of systems and/or processes may be utilized in accordance with embodiments of the disclosure. In further additional embodiments, each physical result may include any number of actions. The elements depicted in FIG. 5 may also be interchangeable with other elements of FIGS. 1-4 and 6-10 as required to realize a particularly desired embodiment.

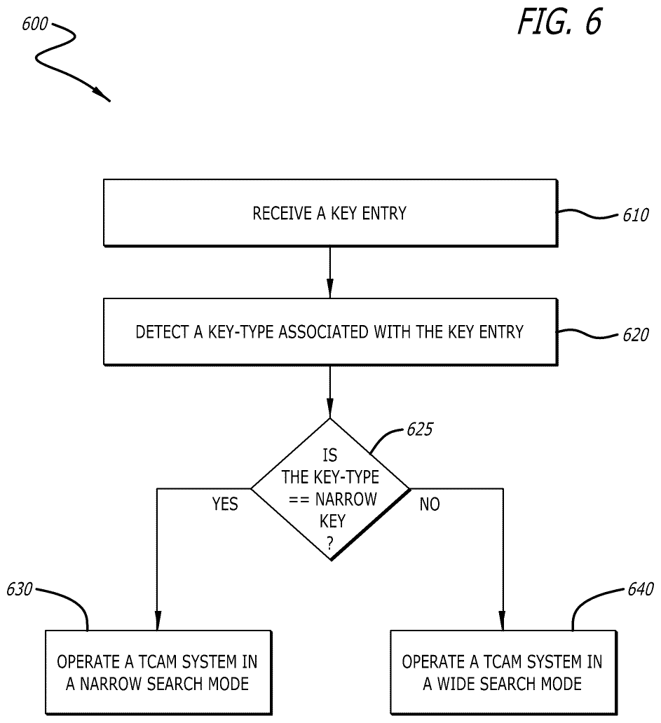

Referring to FIG. 6, a flowchart showing a process 600 for enabling parallel processing in a TCAM system in accordance with various embodiments of the disclosure is shown. In many embodiments, the process 600 can receive a key entry (block 610). A key entry may be associated with a packet. A packet may correspond to a unit of data formatted for transmission across various networks. The packet may contain payload (actual data being transmitted) and control information (such as source and destination addresses, error detection codes). In a number of embodiments, the key entry may be based on one or more of the source address, the destination address, a source port, a destination port, a DSCP, protocol, or the like, associated with the packet. In a variety of embodiments, the key entry may be in a binary form, e.g., represented in 0s and 1s.

In more embodiments, the process 600 may detect a key-type associated with the key entry (block 620). The key-type may correspond to one of a wide key or a narrow key. In additional embodiments, the key-type associated with the key entry may be based on an IP protocol associated with the packet. For example, a key entry of an IPv4 packet can be a narrow key, while a key entry of an IPV6 packet can be a wide key. In further embodiments, the process 600 may detect the key-type associated with the key entry based on a size of the key entry. A size of the narrow key may be smaller than a size of the wide key. For example, the size of the narrow key can be 256 bits and the size of the wide key can be 512 bits.

In yet more embodiments, the process 600 may determine whether the key-type of the key entry is the narrow key (block 625). In still more embodiments, the process 600 may detect the key-type of the key entry based on a narrow key enable signal and a value of an LSB of the key entry. For example, if the LSB of the key entry is set to (‘1’) and the narrow key enable signal is activated, the process 600 may detect the key entry as the narrow key. However, if the LSB of the key entry is set to (‘0’) and the narrow key enable signal is activated, the process 600 may detect the key entry as the wide key. Additionally, the process 600 may detect the key entry as the wide key if the narrow key enable signal is deactivated. In some more embodiments, a size of the narrow key can be 256 bits and a size of the wide key can be 512 bits. Thus, the process 600 may detect the key entry as the narrow key if the size of the key entry is 256 bits and detect the key entry as the wide key if the size of the key entry is 512 bits.

In still yet more embodiments, the process 600 can operate a TCAM system in a narrow search mode in response to detecting that the key-type of the key entry is the narrow key (block 630). The TCAM system may include first and second TCAM blocks, each with a plurality of entries. In many further embodiments, the process 600 may input the key entry to the first and second TCAM blocks to operate the TCAM system in the narrow search mode. In an example, the key entry may be K[255:0]. In such a scenario, the process 600 may input K[255:0] to the first TCAM block and K[255:0] to the second TCAM block. In many additional embodiments, the first and second TCAM blocks may be used to identify one or more hits and one or more misses to the key entry.

In still yet further embodiments, the process 600 can operate a TCAM system in a wide search mode in response to detecting that the key-type is the wide key instead of the narrow key (block 640). In several embodiments, the process 600 may split the key entry into a first key segment and a second key segment, and input the first key segment to the first TCAM block and the second key segment to the second TCAM block to operate the TCAM system in the wide search mode. In an example, when the key entry is K[511:0], the key entry may be split into K1[511:256] and K2[255:0]. Further, the process 600 may input K1[511:256] to the first TCAM block and K2[255:0] to the second TCAM block. In still yet additional embodiments, the first and second TCAM blocks may be used to identify one or more hits and one or more misses to the key entry.

Although a specific embodiment for the process 600 for enabling parallel processing in a TCAM system suitable for carrying out the various steps, processes, methods, and operations described herein is discussed with respect to FIG. 6, any of a variety of systems and/or processes may be utilized in accordance with embodiments of the disclosure. In numerous embodiments, the process 600 may receive the packet and generate the key entry based on the packet. The elements depicted in FIG. 6 may also be interchangeable with other elements of FIGS. 1-5 and 7-10 as required to realize a particularly desired embodiment.

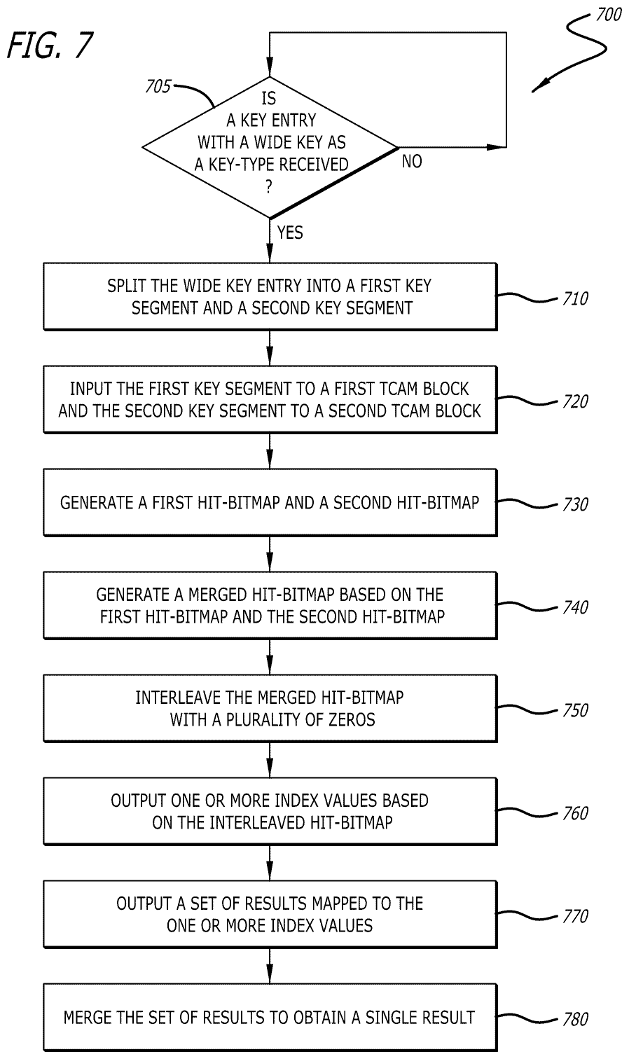

Referring to FIG. 7, a flowchart showing a process 700 for facilitating operation of a TCAM system in a wide search mode in accordance with various embodiments of the disclosure is shown. In many embodiments, the process 700 may determine whether a key entry with a wide key as a key-type is received (block 705). The key entry may be associated with a packet. In a number of embodiments, the process 700 may detect the key-type of the key entry based on a narrow key enable signal and a value of a LSB of the key entry. For example, if the LSB of the key entry is set to (‘0’) and the narrow key enable signal is activated, the process 700 may detect the key entry as the wide key. Additionally, the process 700 may detect the key entry as the wide key if the narrow key enable signal is deactivated. In some more embodiments, a size of a narrow key can be 256 bits and a size of a wide key can be 512 bits. Thus, the process 700 may determine that a wide key is received if the size of the key entry is 512 bits.

In additional embodiments, the process 700 may split the wide key entry into a first key segment and a second key segment (block 710). In further embodiments, the first key segment may correspond to most significant bits of the wide key entry and the second key segment may correspond to the least significant bits of the wide key entry. In an example, when the key entry is K[511:0], the key entry may be split into K1[511:256] that corresponds to the first key segment and K2[255:0] that corresponds to the second key segment.

In still further embodiments, the process 700 can input the first key segment to a first TCAM block of the TCAM system and the second key segment to a second TCAM block of the TCAM system (block 720). In still additional embodiments, each of the first and second TCAM blocks may refer to a specialized type of memory cell array. Each TCAM cell may store one of three states such as 0, 1, and don't care (X). The first and second TCAM blocks may correspond to physical TCAM blocks. Further, the first and second TCAM blocks may be configured to include a first plurality of entries and a second plurality of entries, respectively. In several additional embodiments, the first TCAM block and the second TCAM block may be populated based on at least one logical TCAM. The first and second pluralities of entries may correspond to various rules associated with ACLs, QOS, packet routing, or the like.

In some more embodiments, the first and second TCAM blocks may implement a plurality of logical TCAMs that is associated with a plurality of functions that may include port ACL, security ACL, VLAN ACL, route ACL, or the like. In an example scenario, the logical TCAM can include N number of rows, where each row can either include a 512-bit entry or two 256-bit entries. These entries in the logical TCAM are populated in the first TCAM block and the second TCAM block. For example, each entry in the first TCAM block and the second TCAM block can be 256 bits wide. In such a scenario, the 512-bit entry of the logical TCAM is split into two parts, each being 256 bits wide. These two parts are then separately populated in the first TCAM block and the second TCAM block, respectively, at same index values. Further, the two 256-bit entries in the same row of the logical TCAM are separately populated in the first TCAM block and the second TCAM block, respectively, at same index values. For example, if one of the two 256-bit entries is populated in the first TCAM block at index value ‘4’, the other 256-bit entry gets populated in the second TCAM block at the index value ‘4’.

In yet more embodiments, the process 700 may generate a first hit-bitmap and a second hit-bitmap (block 730). The first TCAM block may be configured to perform a look-up search for the first key segment. For the look-up search, the first TCAM block may compare the first key segment with the first plurality of entries. The first TCAM may compare the first key segment with each of the first plurality of entries, simultaneously. Further, the first TCAM block may identify one or more hits and one or more misses to the first key segment based on the comparison. An entry in the first plurality of entries can be considered as a hit to the first key segment based on a bitwise match between the first key segment and a value of the entry depending on a mask of the entry. An entry in the first plurality of entries can be considered as a miss to the first key segment based on at least one bit mismatch between the first key segment and the value of the entry, except for the don't care bits in the entry.

In several yet more embodiments, the first TCAM block may generate the first hit-bitmap based on the one or more hits and the one or more misses with the first plurality of entries. In other words, in response to receiving the first key segment as the input, the first TCAM block may report the results of the look-up search among the first plurality of entries by generating the first hit-bitmap. The first hit-bitmap may be a binary representation that indicates whether each entry of the first plurality of entries has matched (e.g., a hit) the first key segment or not (e.g., a miss). A number of rows in the first hit-bitmap may be same as the number the first plurality of entries in the first TCAM block to ensure a direct correlation between bit positions and entries themselves. In other words, each bit in the first hit-bitmap may be associated with corresponding entry of the first plurality of entries and can indicate whether the corresponding entry is a hit or miss to the key entry. Similarly, the second TCAM block may also generate the second hit-bitmap in based on the second key segment and the second plurality of entries stored in the second TCAM block. In various embodiments, the first TCAM block and the second TCAM block may generate the first and second hit-bitmaps, parallelly.

In still yet further embodiments, the process 700 may generate a merged hit-bitmap based on the first hit-bitmap and the second hit-bitmap (block 740). In further additional embodiments, the process 700 may perform a logical bitwise AND operation on the first hit-bitmap and the second hit-bitmap to generate the merged hit-bitmap. As the first key segment and the second key segment are portions of the same key entry, performing an AND operation on the first and second hit-bitmaps may ensure that only those bits in the merged hit-bitmap indicate a hit if corresponding bits in both the first and second hit-bitmaps are hits.

In several embodiments, the process 700 can interleave the merged hit-bitmap with a plurality of zeros (block 750). In several yet additional embodiments the process 700 may interleave the merged hit-bitmap with the plurality of zeros to obtain an interleaved hit-bitmap. For example, bits from the merged hit-bitmap can be alternated with zeroes, such as taking one bit from the merged hit-bitmap, then interleaving with a zero, and repeating this pattern. Thus, if the merged hit-bitmap has bits ‘1010’, the interleaved hit-bitmap can be ‘10001000’. In several more embodiments, a hit-bitmap processor may interleave the merged hit-bitmap with the plurality of zeros.

In numerous embodiments, the process 700 may output one or more index values based on the interleaved hit-bitmap (block 760). The interleaved hit-bitmap may include more than one hits to the key entry. In such a scenario, the process 700 may output the one or more index values based on the interleaved hit-bitmap. In yet further embodiments, each of a plurality of priority decoders of the TCAM system may have a corresponding priority index, which defines an order in which the corresponding priority decoder scans through a received hit-bitmap. For example, each of the plurality of priority decoders may scan the interleaved hit-bitmap from the corresponding highest priority index to the corresponding lowest priority index and select the very first set bit that the corresponding priority decoder encounters during the scan. Further, each of the plurality of priority decoders may then generate an index based on the position of the corresponding selected set bit. In certain embodiments, a number of priority decoders in the plurality of priority decoders may be same as the number of entries in the first plurality of entries or the second plurality of entries. In some embodiments, where the first plurality of entries and the second plurality of entries in the first TCAM block and the second TCAM block, respectively, are in the VMR format, the one or more index values outputted by the plurality of priority decoders may correspond to a set of results stored in the first TCAM block and the second TCAM block.

In further additional embodiments, the process 700 may output a set of results mapped to the one or more index values (block 770). In yet additional embodiments, a plurality of AD look-ups of the TCAM system may receive the one or more index values from the plurality of priority decoders. Each of the AD look-ups may output the set of results mapped to the one or more index values. For example, based on the one or more index values, the plurality of AD look-ups may look-up in the first TCAM block and the second TCAM block to retrieve the set of results mapped to the one or more index values.

In yet many embodiments, the process 700 may merge the set of results to obtain a single result (block 780). The single result may be configured to indicate at least one action associated with the key entry. In case of ACLs, the at least one action may correspond to one of permit, deny, or discard. In case of QoS, the at least one action may correspond to one or more QoS policies that indicate marking of the corresponding packet with specific tags or labels for specifying priority of the corresponding packet, indicate header compression of the packet, or the like. In case of QoS, the at least one action may indicate an address of the next hop for the packet.

Although a specific embodiment for the process 700 for facilitating operation of a TCAM system in a wide search mode suitable for carrying out the various steps, processes, methods, and operations described herein is discussed with respect to FIG. 7, any of a variety of systems and/or processes may be utilized in accordance with embodiments of the disclosure. In still more embodiments, a result set for the logical TCAMs may be stored in a dedicated RAM. In such embodiments, based on the one or more index values, the plurality of AD look-ups may look-up in the dedicated RAM to retrieve the set of results mapped to the one or more index values. The elements depicted in FIG. 7 may also be interchangeable with other elements of FIGS. 1-6 and 8-10 as required to realize a particularly desired embodiment.

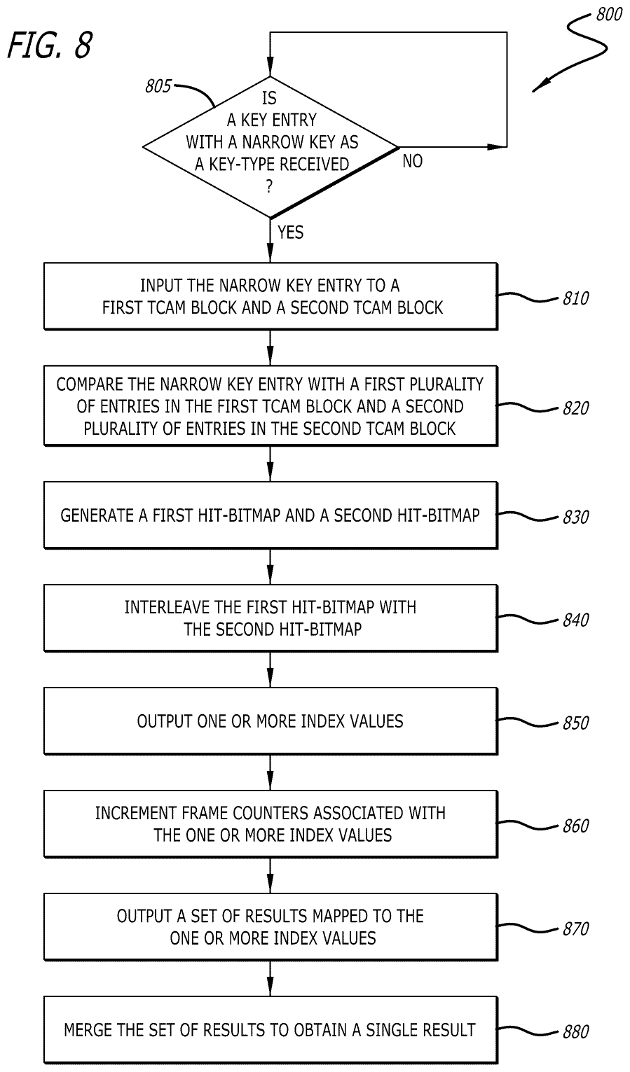

Referring to FIG. 8, a flowchart showing a process 800 for facilitating operation of a TCAM system in a narrow search mode in accordance with various embodiments of the disclosure is shown. In many embodiments, the process 800 may determine whether a key entry with a narrow key as a key-type is received (block 805). The key entry may be associated with a packet. In a number of embodiments, the process 700 may detect the key-type of the key entry based on a narrow key enable signal and a value of a LSB of the key entry. For example, if the LSB of the key entry is set to (‘1’) and the narrow key enable signal is activated, the process 800 may detect the key entry as the narrow key. In further examples,

In still further embodiments, the process 800 can input the narrow key entry to a first TCAM block and a second TCAM block of the TCAM system (block 810). In other words, the TCAM system may be operated in a narrow search mode in response to detecting that the key-type is the narrow key. In an example, the key entry may be K[255:0]. In such a scenario, the process 800 may input K[255:0] to the first TCAM block and K[255:0] to the second TCAM block.

In further additional embodiments, the process 800 may compare the narrow key entry with a first plurality of entries and a second plurality of entries (block 820). In still yet further embodiments, the first TCAM block may include the first plurality of entries and the second TCAM block may include the second plurality of entries. In further additional embodiments, the narrow key entry may be compared with each of the first plurality of entries, simultaneously. In many further embodiments, the process 800 may identify one or more hits and one or more misses to the key entry based on the comparison. An entry in the first plurality of entries can be considered as a hit to the key entry based on a bitwise match between the key entry and a value of the entry depending on a mask of the entry. An entry in the first plurality of entries can be considered as a miss to the key entry based on at least one bit mismatch between the key entry and the value of the entry, except for the don't care bits in the entry.

In many additional embodiments, the process 800 may generate a first hit-bitmap and a second hit-bitmap (block 830). The process 800 may generate the first hit-bitmap based on the one or more hits and the one or more misses with the first plurality of entries. In other words, in response to receiving the key entry as the input, the first TCAM block may report the results of the look-up search among the first plurality of entries by generating the first hit-bitmap. The first hit-bitmap may be a binary representation that indicates whether each entry of the first plurality of entries has matched (e.g., a hit) the key entry or not (e.g., a miss). A number of rows in the first hit-bitmap may be same as the number the first plurality of entries in the first TCAM block to ensure a direct correlation between bit positions and entries themselves. In other words, each bit in the first hit-bitmap may be associated with corresponding entry of the first plurality of entries and can indicate whether the corresponding entry is a hit or miss to the key entry. In an example, if an entry in the first TCAM block matches the key entry, a corresponding bit in the first hit-bitmap can be set to ‘1’ (indicating a hit); however, if the entry does not match the key entry, the corresponding bit can be set to ‘0’ (indicating a miss). Similarly, the second TCAM block may also generate the second hit-bitmap based on the same narrow key inputted to the first TCAM block and the second plurality of entries.

In several embodiments, the process 800 can interleave the first hit-bitmap with the second hit-bitmap (block 840). The process 800 may interleave the first hit-bitmap with the second hit-bitmap to obtain an interleaved hit-bitmap. For example, bits from the first hit-bitmap and the second hit-bitmap can be alternated, such as taking one bit from the first hit-bitmap, then one bit from the second hit-bitmap, and repeating this pattern. Thus, if the first hit-bitmap has bits ‘1010’ and the second hit-bitmap has bits ‘0101’, the interleaved hit-bitmap can be ‘10011001’. In several more embodiments, a hit-bitmap processor of the TCAM system may interleave the first hit-bitmap with the second hit-bitmap.

In numerous embodiments, the process 800 may output one or more index values based on the interleaved hit-bitmap (block 850). The interleaved hit-bitmap may include more than one hits to the key entry. In such a scenario, the process 800 may output the one or more index values based on the interleaved hit-bitmap. In yet further embodiments, each of a plurality of priority decoders of the TCAM system may have a corresponding priority index, which defines an order in which the corresponding priority decoder scans through a received hit-bitmap. For example, each of the plurality of priority decoders may scan the interleaved hit-bitmap from the corresponding highest priority index to the corresponding lowest priority index and select the very first set bit that the corresponding priority decoder encounters during the scan. Further, each of the plurality of priority decoders may then generate an index based on the position of the corresponding selected set bit. In certain embodiments, a number of priority decoders in the plurality of priority decoders may be same as the number of entries in the first plurality of entries or the second plurality of entries. In some embodiments, where the first plurality of entries and the second plurality of entries in the first TCAM block and the second TCAM block, respectively, are in the VMR format, the one or more index values outputted by the plurality of priority decoders may correspond to a set of results stored in the first TCAM block and the second TCAM block.

In yet more embodiments, the process 800 can increment frame counters associated with the one or more index values (block 860). In a variety of embodiments, each entry in the first TCAM block and the second TCAM block may be associated with a separate frame counter. In such embodiments, each frame counter may be incremented each time an index value corresponding to the entry is outputted by any of the plurality of priority decoders.

In further additional embodiments, the process 800 may output a set of results mapped to the one or more index values (block 870). In yet additional embodiments, a plurality of AD look-ups of the TCAM system may be configured to receive the one or more index values from the plurality of priority decoders. Each of the AD look-ups may output a set of results mapped to the one or more index values. For example, based on the one or more index values, the plurality of AD look-ups may look-up in the first TCAM block and the second TCAM block (or a dedicated RAM) to retrieve the set of results mapped to the one or more index values.

In yet many embodiments, the process 800 may merge the set of results to obtain a single result (block 880). The single result may be configured to indicate at least one action associated with the key entry. In case of ACLs, the at least one action may correspond to one of permit, deny, or discard. In case of QoS, the at least one action may correspond to one or more QoS policies that indicate marking of the corresponding packet with specific tags or labels for specifying priority of the corresponding packet, indicate header compression of the packet, or the like. In case of QoS, the at least one action may indicate an address of the next hop for the packet.

Although a specific embodiment for the process 800 for facilitating operation of a TCAM system in a narrow search mode suitable for carrying out the various steps, processes, methods, and operations described herein is discussed with respect to FIG. 8, any of a variety of systems and/or processes may be utilized in accordance with embodiments of the disclosure. In still more embodiments, a size of the narrow key can be 256 bits and a size of a wide key can be 512 bits. Thus, the process 800 may determine that a narrow key is received if the size of the key entry is 256 bits. Further, the frame counters associated entries in the first TCAM block and the second TCAM block can be incremented during the wide search mode, without deviating from the scope of the disclosure. The elements depicted in FIG. 8 may also be interchangeable with other elements of FIGS. 1-7 and 9-10 as required to realize a particularly desired embodiment.

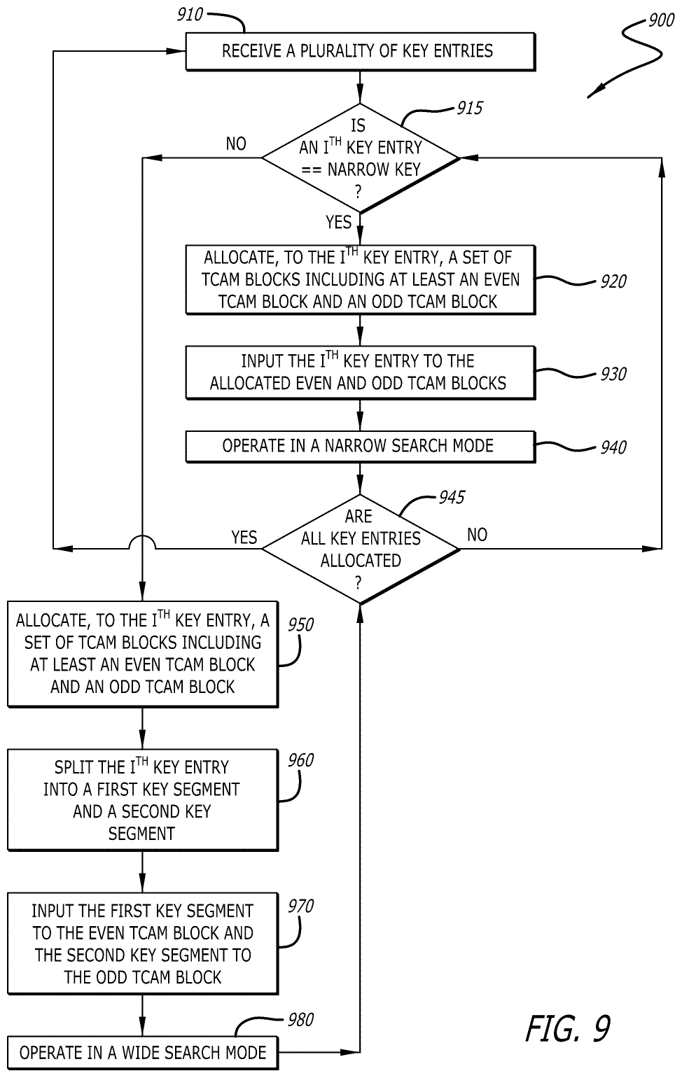

Referring to FIG. 9, a flowchart showing a process 900 for enabling parallel processing in a TCAM system in accordance with various embodiments of the disclosure is shown. The process 900 may receive a plurality of key entries (block 910). Each key entry of the plurality of key entries may be associated with a packet. A packet may correspond to a unit of data formatted for transmission across various networks. The packet may contain payload (actual data being transmitted) and control information (such as source and destination addresses, error detection codes). In a number of embodiments, each key entry may be based on one or more of the source address, the destination address, a source port, a destination port, a DSCP, protocol, or the like, associated with the corresponding packet. In a variety of embodiments, each key entry may be in a binary form, e.g., represented in 0s and 1s. In various embodiments, at least two key entries may be associated with the same packet. For example, one key entry may be received for a forward ACL check and the other key entry may be received for a post-forward ACL check, for the same packet.

In more embodiments, the process 900 may be configured to determine whether an i^{th} key entry of the plurality of key entries is a narrow key (block 915). For example, a key entry of an IP version 4 (IPv4) packet can be a narrow key, while a key entry of an IPV6 packet can be a wide key. In further embodiments, the process 900 may detect a key-type associated with the i^{th} key entry based on a size of the i^{th} key entry. A size of the narrow key may be smaller than a size of the wide key. For example, the size of the narrow key can be 256 bits and the size of the wide key can be 512 bits.

In still more embodiments, the process 900 may detect the key-type of the i^{th} key entry based on a narrow key enable signal and a value of a LSB of the i^{th} key entry. For example, if the LSB of the i^{th} key entry is set to (‘1’) and the narrow key enable signal is activated, the process 900 may detect the i^{th} key entry as the narrow key. However, if the LSB of the i^{th} key entry is set to (‘0’) and the narrow key enable signal is activated, the process 900 may detect the i^{th} key entry as the wide key. Additionally, the process 600 may detect the i^{th} key entry as the wide key if the narrow key enable signal is deactivated. In some more embodiments, a size of the narrow key can be 256 bits and a size of the wide key can be 512 bits. Thus, the process 900 may detect the i^{th} key entry as the narrow key if the size of the i^{th} key entry is 256 bits and detect the i^{th} key entry as the wide key if the size of the i^{th} key entry is 512 bits.

In still further embodiments, the process 900 may allocate a set of TCAM blocks including at least an even TCAM block and an odd TCAM block to the i^{th} key entry (block 920). The process 900 may allocate the set of TCAM blocks to the i^{th} key entry in response to the determination that the i^{th} key entry is the narrow key. In still additional embodiments, the TCAM system may include a first TCAM and a second TCAM. Further, the first TCAM may include a plurality of even TCAM blocks. Similarly, the second TCAM may include a plurality of odd TCAM blocks. In yet more embodiments, the first TCAM and the second TCAM may correspond to physical TCAMs. A physical TCAM may refer to a hardware component that includes an array of memory cells. The even TCAM blocks and the odd TCAM blocks may be populated based on one or more logical TCAMs. In other words, the even TCAM blocks and the odd TCAM blocks may be utilized to implement the one or more logical TCAMs.

In still yet more embodiments, the process 900 may input the i^{th} key entry to the allocated even and odd TCAM blocks (block 930). For the sake of the ongoing discussion, it is assumed that the set of TCAM blocks includes one even TCAM block and one odd TCAM block. In such a scenario, the process 900 may input the i^{th} key entry to the even TCAM block and the odd TCAM block. Each of the even and odd TCAM block may include a plurality of entries. The pluralities of entries may correspond to one or more of ACLs, QOS, packet routing information, or the like. In an example scenario, a first logical TCAM can include N number of rows, where each row can either include a 512-bit entry or two 256-bit entries. These entries in the first logical TCAM are populated in the even TCAM block and the odd TCAM block. For example, each entry in the even TCAM block and the odd TCAM block can be 256 bits wide. In such a scenario, the 512-bit entry of the first logical TCAM is split into two parts, each being 256 bits wide. These two parts are then separately populated in the even TCAM block and the odd TCAM block, respectively, at same index values. Further, the two 256-bit entries in the same row of the first logical TCAM are separately populated in the even TCAM block and the odd TCAM block, respectively, at same index values. For example, if one of the two 256-bit entries is populated in the even TCAM block at index value ‘4’, the other 256-bit entry gets populated in the odd TCAM block at the index value ‘4’. Similarly, remaining even TCAM blocks of the plurality of TCAM blocks and remaining odd TCAM blocks of the plurality of TCAM blocks can be populated based on one or more other logical TCAMs.

In many further embodiments, the process 900 can operate the even TCAM block and the odd TCAM block in a narrow search mode (block 940). The even TCAM block may generate a first hit-bitmap based on the i^{th} key entry and a first plurality of entries stored on in the even TCAM block. The first hit-bitmap may indicate which all entries among the first plurality of entries matched the i^{th} key entry. Likewise, in response to receiving the key entry key entry, the odd TCAM block may generate a second hit-bitmap based on the key entry key entry and a second plurality of entries stored on in the odd TCAM block. In many additional embodiments, process 900 may interleave the first hit-bitmap with the second hit-bitmap to obtain an interleaved hit-bitmap. In numerous embodiments, the process 900 may output one or more index values based on the interleaved hit-bitmap. In yet additional embodiments, the process 900 can output a set of results mapped to the one or more index values. In a variety of additional embodiments, the process 900 may merge the set of results to obtain a single result for the i^{th} key entry. The single result may be configured to indicate one or more actions associated with the i^{th} key entry.

In several embodiments, the process 900 may determine whether all key entries of the plurality of key entries are allocated with a set of TCAM blocks (block 945). In several more embodiments, in response to determining that at least one key entry (e.g., i=(i+1)^{th} key entry) of the plurality of key entries is not allocated with a set of TCAM blocks, the process 900 may determine whether the subsequent i^{th} key entry is a narrow key (block 915). In many additional embodiments, in response to determining that all the key entries of the plurality of key entries are allocated with a set of TCAM blocks, the process 900 may wait to receive new plurality of key entries (block 910). Each key entry of the plurality of key entries may be processed in a manner similar to the i^{th} key entry. Additionally, the plurality of keys may be processed in parallel.

In furthermore embodiments, if the i^{th} key entry is not a narrow key, the process 900 may allocate a set of TCAM blocks including at least an even TCAM block and an odd TCAM block to the i^{th} key entry (block 950). The process 900 may allocate the set of TCAM blocks to the i^{th} key entry in response to the determination that the i^{th} key entry is the wide key.

In yet further embodiments, the process 900 may split the i^{th} key entry to a first key segment and a second key segment (block 960). In further embodiments, the first key segment may correspond to most significant bits of the i^{th} key entry and the second key segment may correspond to the least significant bits of the i^{th} key entry. In an example, when the i^{th} key entry is K[511:0], the i^{th} key entry may be split into K1[511:256] that corresponds to the first key segment and K2[255:0] that corresponds to the second key segment.

In several additional embodiments, the process 900 can input the first key segment to the even TCAM block and the odd key segment to the odd TCAM block (block 970). Each of the even and odd TCAM block may include a plurality of entries. The pluralities of entries may correspond to one or more of ACLs, QoS, packet routing information, or the like. In numerous additional embodiments, the process 900 may operate the allocated even and odd TCAM blocks in the wide search mode (block 980). The even TCAM block may generate a first hit-bitmap based on the first key segment and the first plurality of entries stored on in the even TCAM block. The first hit-bitmap may indicate which all entries among the first plurality of entries matched the first key segment. Likewise, in response to receiving the second key segment, the odd TCAM block may generate a second hit-bitmap based on the second key segment and a second plurality of entries stored on in the odd TCAM block. In more additional embodiments, process 900 may merge the first hit-bitmap and the second hit-bitmap based on a logical bitwise AND operation and interleave the merged hit-bitmap with a plurality of zeros to obtain an interleaved hit-bitmap.

In further numerous embodiments, the process 900 may output one or more index values based on the interleaved hit-bitmap. In yet further embodiments, the process 900 can output a set of results mapped to the one or more index values. In a variety of embodiments, the process 900 may merge the set of results to obtain a single result for the i^{th} key entry. The single result may be configured to indicate one or more actions associated with the i^{th} key entry. Further, the process 900 may determine whether all key entries of the plurality of key entries are allocated with a set of TCAM blocks (block 945). In several more embodiments, in response to determining that at least one key entry (e.g., i=(i+1)^{th} key entry) of the plurality of key entries is not allocated with a set of TCAM blocks, the process 900 may determine whether the subsequent i^{th} key entry is a narrow key (block 915).

Although a specific embodiment for the process 900 for enabling parallel processing in a TCAM system suitable for carrying out the various steps, processes, methods, and operations described herein is discussed with respect to FIG. 9, any of a variety of systems and/or processes may be utilized in accordance with embodiments of the disclosure. In still more embodiments, one or more first logical TCAMs in the TCAM system may be associated with forward ACLs and one or more second logical TCAMs in the TCAM system may be associated with post-forward ACLs. The elements depicted in FIG. 9 may also be interchangeable with other elements of FIGS. 1-8 and 10 as required to realize a particularly desired embodiment.

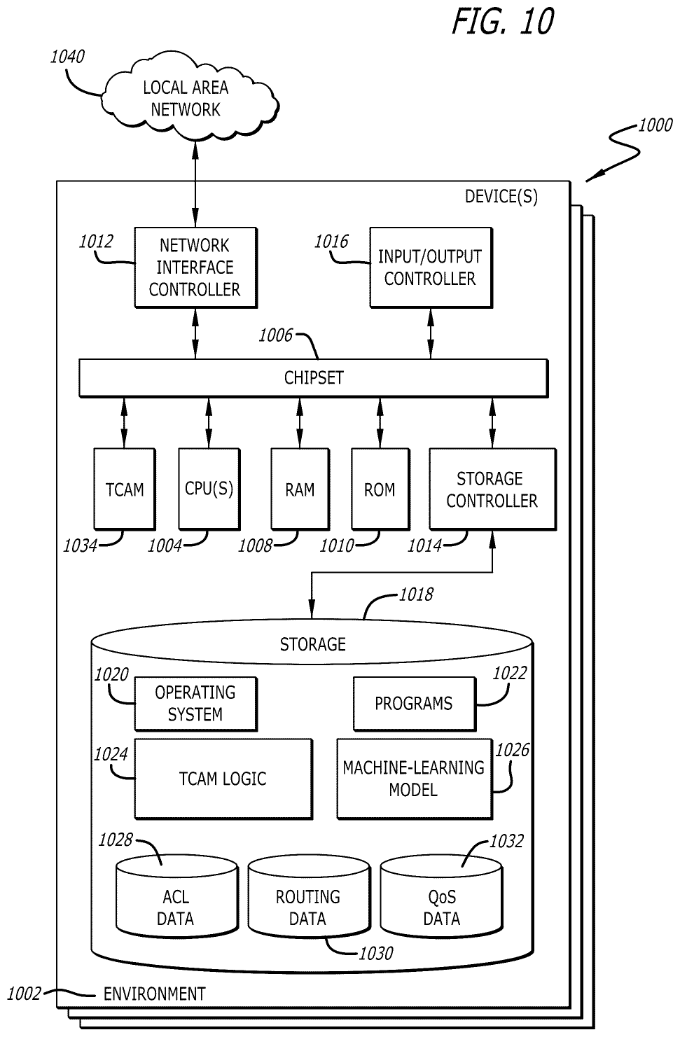

Referring to FIG. 10, a conceptual block diagram of a device 1000 suitable for configuration with a TCAM logic in accordance with various embodiments of the disclosure is shown. The embodiment of the conceptual block diagram depicted in FIG. 10 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 1000 may, in some examples, correspond to physical devices and/or to virtual resources and embodiments described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to communicatively couple a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, ACL data 1028, Routing data 1030, and QoS data 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-7. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a TCAM logic 1024 that can be configured to perform one or more of the various steps, processes, operations, and/or other methods that are described above. Often, the TCAM logic 1024 can be a set of instructions stored within a non-volatile memory that, when executed by the controller(s)/processor(s) 1004, can carry out these steps, etc. In a variety of embodiments, the TCAM logic 1024 may be configured to receive a key entry associated with a packet and determine a key-type associated with the key entry. The TCAM logic 1024 may further operate the device 1000 (e.g., a TCAM 1034) in one of a narrow search mode and a wide search mode based on the detected key-type. The TCAM logic 1024 may input the key entry to first and second TCAM blocks in the TCAM 1034 to operate the device 1000 in the narrow search mode. Alternatively, the TCAM logic 1024 may split the key entry into two segments and input one segment to one TCAM block and another segment to another TCAM block to operate the device 1000 in the wide search mode.

Additionally, the TCAM logic 1024 may facilitate implementation of multiple logical TCAMs using at least two physical TCAM blocks. In some embodiments, the TCAM logic 1024 may be a client application that resides on a network-connected device, such as, but not limited to, a server, switch, personal or mobile computing device in a single or distributed arrangement. In certain embodiments, the TCAM logic 1024 can be a dedicated hardware device, cloud-based service, or be configured into a system on a chip package (FPGA, ASIC, or the like).

In a number of embodiments, the storage 1018 can include the ACL data 1028. As discussed above, the ACL data 1028 may include various sets of rules associated with various ACL's such as port ACL, VLAN ACL, route ACL, security ACL, or the like. In many embodiments, the ACL data 1028 may be in a binary format. The TCAM logic 1024 may store the ACL data 1028 in the storage 1018. Additionally, the TCAM logic 1024 may utilize the ACL data 1028 to allow or deny access to a received packet.

In still more embodiments, the storage 1018 can include routing data 1030. As discussed above, routing data 1030 may include at least one of a MAC address or an internet protocol (IP) address associated with a plurality of devices. The TCAM logic 1024 may store the routing data 1030 in the storage 1018. Additionally, the TCAM logic 1024 may utilize the routing data 1030 to determine a next-hop for a received packet.

In still more embodiments, the storage 1018 can include the QoS data 1032. As discussed above, the QoS data 1032 may include a plurality of QoS policies. QoS data 1032 may aid in high-speed packet classification and filtering to prioritize network traffic and ensure optimal performance for critical applications. Additionally, the TCAM logic 1024 may store the QoS data 1032 in the storage 1018. The TCAM logic 1024 may utilize QoS data 1032 to implement QoS policies on a received data packet.

Finally, in many embodiments, data may be processed into a format usable by a machine-learning model 1026 (e.g., feature vectors, etc.), and or other pre-processing techniques. The machine learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn the pattern of a network's current setup and/or any security needs of various network devices and generate predictions, configurations, and/or confidence levels regarding disaster recovery of a network for workload protection and/or segmentation, etc. In some embodiments, the ML model 1026 can be configured to determine which method of generating those predictions would work best based on certain conditions or with certain network devices. In additional embodiments, the ML model 1026 may learn to predict one or more rules associated with one or more logical TCAMs. In other words, the ML model 1026 may learn to populate the set of rules associated with a logical TCAM in physical TCAMs.

The ML model(s) 1026 can be configured to generate inferences to make predictions or draw conclusions from data. An inference can be considered the output of a process of applying a model to new data. This can occur by learning from at least the ACL data 1028, the routing data 1030, and the QoS data 1032, and/or the underlying algorithmic data and use that learning to predict future configurations, outcomes, and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes. The training set of the ML model(s) 1026 can be provided by the manufacturer prior to deployment and can be based on previously verified data.

In many embodiments, a TCAM 1034 can be configured to operate in conjunction with the chipset 1006. In a number of embodiments, the TCAM 1034 may correspond to a TCAM system described in conjunction with FIG. 2. In a variety of embodiments, the TCAM 1034 may correspond to a TCAM system described in conjunction with FIG. 4. Further, the TCAM 1034 can be operated in the narrow search mode or the wide search mode as per the requirement. Furthermore, the TCAM 1034 may include one or more physical TCAMs populated based on one or more logical TCAMs.

Although a specific embodiment for a device 1000 suitable for configuration with the TCAM logic 1024 suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices such that each acts as a device and the TCAM logic 1024 acts in tandem between the devices. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A ternary content addressable memory (TCAM) system, comprising:
a first TCAM block and a second TCAM block; and
a TCAM logic configured to:
receive a key entry;
detect a key-type associated with the key entry; and
operate the TCAM system in one of a wide search mode or a narrow search mode based on the detected key-type, wherein:
in the narrow search mode, the TCAM logic is further configured to input the key entry to the first TCAM block and the second TCAM block, and
in the wide search mode, the TCAM logic is further configured to:
split the key entry into a first key segment and a second key segment; and
input the first key segment and the second key segment to the first TCAM block and the second TCAM block, respectively.

2. The TCAM system of claim 1, wherein the first TCAM block and the second TCAM block are physical TCAM blocks.

3. The TCAM system of claim 1, wherein the first TCAM block and the second TCAM block are populated based on at least one logical TCAM.

4. The TCAM system of claim 3, wherein the at least one logical TCAM comprises one or more 512-bit entries and one or more 256-bit entries.

5. The TCAM system of claim 1, wherein the first TCAM block is configured to store a first plurality of entries and the second TCAM block is configured to store a second plurality of entries.

6. The TCAM system of claim 5, further comprising:
a plurality of priority decoders coupled to the first TCAM block and the second TCAM block; and
a plurality of associated data look-ups coupled to the plurality of priority decoders.

7. The TCAM system of claim 6, wherein the key-type is one of a narrow key or a wide key.

8. The TCAM system of claim 7, wherein a size of the narrow key is smaller than a size of the wide key.

9. The TCAM system of claim 7, wherein the TCAM logic is further configured to operate the TCAM system in the narrow search mode in response to detecting that the key-type is the narrow key.

10. The TCAM system of claim 9, wherein in response to inputting the key entry to the first TCAM block and the second TCAM block:
the first TCAM block is further configured to generate a first hit-bitmap based on the key entry and the first plurality of entries, and
the second TCAM block is further configured to generate a second hit-bitmap based on the key entry and the second plurality of entries.

11. The TCAM system of claim 10, wherein the TCAM logic is further configured to:
interleave the first hit-bitmap with the second hit-bitmap to obtain an interleaved hit-bitmap; and
provide the interleaved hit-bitmap to the plurality of priority decoders.

12. The TCAM system of claim 11, wherein:
the plurality of priority decoders is configured to output one or more index values based on the interleaved hit-bitmap, and
the plurality of associated data look-ups is configured to output a set of results mapped to the one or more index values.

13. The TCAM system of claim 12, wherein the TCAM logic is further configured to:
merge the set of results; and
obtain, based on the merging of the set of results, a single result configured to indicate at least one action.

14. The TCAM system of claim 7, wherein the TCAM logic is further configured to operate the TCAM system in the wide search mode in response to detecting that the key-type is the wide key.

15. The TCAM system of claim 14, wherein in response to inputting the first key segment to the first TCAM block and the second key segment to the second TCAM block:
the first TCAM block is further configured to generate a first hit-bitmap based on the inputted first key segment and the first plurality of entries, and
the second TCAM block is further configured to generate a second hit-bitmap based on the inputted second key segment and the second plurality of entries.

16. The TCAM system of claim 15, wherein the TCAM logic is further configured to:
generate a merged hit-bitmap based on the first hit-bitmap and the second hit-bitmap; and
interleave the merged hit-bitmap with a plurality of zeros to obtain an interleaved hit-bitmap.

17. The TCAM system of claim 16, wherein:
the plurality of priority decoders is configured to output one or more index values based on the interleaved hit-bitmap, and
the plurality of associated data look-ups is configured to output a set of results mapped to the one or more index values.

18. The TCAM system of claim 17, wherein the TCAM logic is further configured to:
merge the set of results; and
obtain, based on the merging of the set of results, a single result configured to indicate at least one action.

19. A ternary content addressable memory (TCAM) system, comprising:
a plurality of TCAMs comprising at least a first TCAM and a second TCAM, wherein:
the first TCAM comprises a plurality of even TCAM blocks, and
the second TCAM comprises a plurality of odd TCAM blocks; and
a TCAM logic configured to:
receive a plurality of key entries; and
allocate a set of TCAM blocks to each key entry of the plurality of key entries, wherein:
the set of TCAM blocks comprises at least an even TCAM block and an odd TCAM block, and
the set of TCAM blocks allocated to each key entry is utilized to identify one or more hits to a corresponding key entry.

20. A method, comprising:
receiving a key entry;
detecting a key-type associated with the key entry; and
operating a ternary content addressable memory (TCAM) system, comprising at least a first TCAM block and a second TCAM block, in one of a wide search mode or a narrow search mode based on the detected key-type, wherein:
operating the TCAM system in the narrow search mode comprises inputting the key entry to the first TCAM block and the second TCAM, and
operating the TCAM system in the wide search mode comprises splitting the key entry into a first key segment and a second key segment, and inputting the first key segment and the second key segment to the first TCAM block and the second TCAM block, respectively.
